(19) United States
(12) Patent Application Publication
(10) Pub. No.: US 2003/0149594 A1
(43) Pub. Date: Aug. 7, 2003

(54) System and method for secure highway for real-time preadjudication and payment of medical claims

(76) Inventors: Donald E. Beazley, Fort Lauderdale, FL (US); Jacob Nudel, Fort Lauderdale, FL (US)

Correspondence Address: Supervisor, Patent Prosecution Services, PIPER RUDNICK LLP, 1200 Nineteenth Street, N.W., Washington, DC, 20036-2412, US

(21) Appl. No.: 10/121,615

(22) Filed: Apr. 15, 2002

Related U.S. Application Data
(60) Provisional application No. 60/283,333, filed on Apr. 13, 2001.

(51) Int. Cl. G06F 17/60

(52) U.S. Cl. 705/2; 705/40

(57) ABSTRACT

A system and method for real-time pre-adjudication, funding and payment of medical expenses to a Provider for a Claim, the Claim having a Payer, wherein a line of credit is established that is associated with the Claim. One variation of the system provides automated and optionally network-based assistance to Participants in the health industry. The Participants include: Providers, Payers, Funding Institution, Patients, Employers, and E-Market Exchanges. The method of the system includes: receiving a medical expenses Claim which is scrubbed; prior to adjudication of the Claim funding the Provider from a line of credit, with funding determined using risk analysis tools and utilizing a recorded security interest; collecting payment from the Payer via a secured environment; and repaying the line of credit from the collected Payer payment with follow-up reporting and record keeping.

This application claims priority from U.S. Provisional Application Serial No. 60/283,333 filed Apr. 13, 2001. The entirety of that provisional application is incorporated herein by reference.

### BACKGROUND OF THE INVENTION

1. Field of the Invention

The present invention relates to methods and systems for providing a secure highway for real-time pre-adjudication and payment of medical Claims, and in particular to methods and systems for providing users, including Providers, Payers, and Funding Institutions, with real-time pre-adjudication and payment of medical Claims via a network, such as the Internet.

2. Related Art

U.S. Pat. No. 5,644,778 to Burks, et al., discloses a medical transaction system capable of permitting a plurality of healthcare Providers to communicate with a plurality of Payers and financial institutions, and includes a financial transactor that uses remittance information from Payers to generate electronic funds transfer messages to credit and debit accounts, and supports a medical line of credit at financial institutions usable to pay portions of medical claims not covered by Payers following adjudication.

U.S. Pat. No. 5,950,169 to Borghesi, et al., discloses a method and system for managing and processing general insurance Claims using an object oriented graphical user interface (GUI).

U.S. Pat. No. 5,301,105 to Cummings, discloses an integrated and comprehensive health care system to provide interconnection and interaction of the Patient, health care Provider, Funding Entity, Payer, utilization reviewer, and Employer to provide pretreatment, treatment, and post-treatment health care and predetermined financial support information.

U.S. Pat. No. 5,832,447 to Rieker, et al., discloses an automated system and method for requesting real-time electronic insurance eligibility verification information from health care insurance Payers.

None of the related art discloses or suggests integrating multiple Providers, Payers, and Funding Entities for real-time submission, pre-adjudication, and advanced funding of Claims prior to approval of the Payer, rather than following adjudication. In addition, the related art does not teach or suggest of verified enhanced term sheets or other mechanisms for estimating or analyzing risk for purposes of pre-adjudication funding, not does the related art teach or suggest providing such funding using secured loans or other secured mechanisms based on outstanding Claims. Furthermore, the related art does not teach or suggest the features of an electronic lockbox and an electronic settlement.

### BACKGROUND OF THE TECHNOLOGY

Health care is the largest and fastest growing market in the United States. It accounts for over 14% of the Gross National Product. It is estimated that total U.S. healthcare spending will nearly double from $1.1 trillion in 1998 to $2.1 trillion in 2007. Longer life expectancies and an aging baby boomer population are driving this growth. It is also one of the most unique industries in the United States for the following reasons: Patients are not in direct control of monies to fund healthcare coverage; Employers provide contractual and funding agreement with Payers; the healthcare industry is regionalized and fragmented; Patients do not pay directly for care and thus are not price sensitive; and significant federal and state regulation exists for the industry.

The health care market sector is fragmented into hundreds of thousands of individual Providers of care, making it difficult for the industry to avail itself of the efficiencies of the Internet. For example, there are approximately 650,000 physicians in the United States. In 1999, Manhattan Research found that 200,000 physicians regularly used the Internet with the number to grow to 300,000 by 2002. Physicians are primarily using the Internet for communications and researching medical and drug information.

It should be noted that one of the areas of resistance in the forward movement of Internet commerce is related to security and privacy issues. Present and future government legislation, including the Health Insurance Portability and Accountability Act (HIPAA), and a Gramm-Leach-Bliley Act relating to financial privacy, is important in setting minimum standards. HIPAA mandates that by October 2003, any entity transmitting Claims or any related health care transactions electronically must use standard forms and formats. The electronic Claim proposal also included new standards for other common transactions and for reporting diagnoses and procedures in the transactions. Under these proposals, Payers are able to authorize services, certify referrals and coordinate benefits using one standard electronic format for each transaction.

HIPAA does not require that health care transactions be transmitted electronically, but that Payer systems must be able to accept transactions in formats established by the American National Standards Institute. Protocols of the present invention allow Payers to accept submission of Claims, eligibility and referral information and requests, as well as benefit determinations in real-time and allow them to respond using the standard, compliant transaction set.

The effects of HIPAA are already being felt as measured by the percentage of Claims filed in electronic format. In 1991, less than 20% of Claims by Providers and 25% of all medical Claims were filed electronically. As of 1998, close to 40% of Provider Claims were filed electronically with all medical Claims exceeding 50%. Much of the growth in filing of electronic Claims is attributable to Claims clearing houses rather than the Payer/Provider directly linking up. Almost all of these Claims filed electronically were done in an Electronic Data Interchange (“EDI”) environment, rather than via the Internet.

Physicians and other ancillary service Providers (e.g., pharmacies, laboratories, outpatient centers, diagnostic facilities) and Payers constitute a huge, uncoordinated matrix which functions mostly on a local or regional level. These factors have increased the number of Claims, as have the following: continuing development of new medical technology; aging of the population; extension of health care insurance coverage to more people; and increasing incidence of fraud and abuse and the increased cost of medical compliance.

For the physicians, the delivery of medical care to their Patients has become more and more difficult and costly. Some of the factors affecting physicians include: reductions in fee schedules; increasing demand for documentation of what is performed; the need to practice more defensively due to the litigious nature of the medical environment; increasing consumerism and more demanding and older, sicker Patients; voluminous amounts of paperwork and procedures from the various Payer organizations; higher office operating and overhead costs; significant time delays between filing Claims for services provided and payment received, and even longer for initially rejected Claims; increased surveillance by the government with respect to fraud and abuse issues; and more hours of work, seeing more Patients and less income.

The health care transaction cost factor as outlined in the June 1999 “Health Web Watch” study by Punk, Ziegel and Company exceeds $300 billion annually. The Health Web Watch study estimates that over 50% of this cost could be eliminated through the adoption of Internet based solutions for health care transactions. Given the American Medical Association's(AMA) estimate of $54 billion in Claims processing cost alone, a potential savings of $27 billion or $4.22 per Claim is thus attainable. Additionally, the Health Web Watch study estimates that inefficient access to clinical information costs the health care industry hundreds of millions of dollars annually in sub-optimal, under and over treatment.

The cost of Claims preparation, Claims examination, call center support, fraud and abuse and overhead associated with systems and personnel to execute these activities is a cost borne by Payers and does not even consider the Provider based costs associated with the process. This large market is driven by the growth of health care services, inefficiencies in delivery and low productivity that result from non-communicating legacy systems. The need for large volumes of paperwork and the need for human voice communication to accomplish even basic business and financial transactions has become a crisis. Many competitors lack product focus, or languish with product design problems.

There have been many attempts to control actual medical costs and their associated administrative costs. These attempts have been largely unsuccessful due to the absolute increase in the volume of care, advancing medical technology, the aging of the population, the significant amount of fraud and abuse, and the increasingly stringent regulation by both Payers and oversight agencies (including state and federal governments). As indicted in the related art, current attempts to solve this problem focus on electronic filing of Claims, usually during a daily batch transmission to a Claims clearing house, which then forwards the Claim to the appropriate Payer. After that, all disputes and issues relating to a Claim and its status become the responsibility of the Provider.

There is thus a need in the current art for an efficient, accurate, and timely facilitation of Claim payment. There is a need for a significantly positive impact on the cost and operational aspects of the financial and administrative side of health care delivery. There is also a need to create future efficiencies based on newly created connectivity and integrated data. The future efficiencies can be found by aggregating previously unnetworked and disassociated Providers, Payers, and depositories. There is also a need for pre-adjudication of claims and funding, and decision-making tools to assist in determining advanced payment of claims and funding. There is also a need for these functions to be performed in real-time. In addition, there is a need for secured advanced finding.

### SUMMARY OF THE INVENTION

The present invention solves the above needs by providing a system and method for real-time pre-adjudication, pre-funding, and payment of medical Claims via a network, such as the Internet. In particular, the present invention relates to a system and method for real-time pre-adjudication and payment of medical expenses to a Provider for a Claimant, the Claimant having a Payer, wherein a line of credit is established that is associated with the Claimant. In addition, embodiments of the present invention include a Secured Straight Through Processing (SSTP) function.

The system of the present invention comprises: a system for automated and optimally network-based assistance to the Participants in the health care industry, referred to in one embodiment as a Claims Online Network Clearing Exchange in Real-Time (CONCERT); an Internet, Virtual Private Network (VPN), or other network; a Proxy Server; a Browser; an Interface; a Call Center; a Clearing House; a Firewall; and Participant computers. The Participants comprise: Providers (such as physicians), Payers (such as insurance companies), Funding Institution (such as banks), Patients, Employers, and E-Market Exchanges.

The present invention efficiently, accurately, and timely facilitates Claim payment. Providers, Payers, and Funding Entities are united so that at the point of service, funds can be advance to the Providers. This is done through a SSTP arrangement from the inception to the gathering and disbursement of claims processing. A Verified Enhanced Term Sheet (VETS) analysis verifies from the inception, the existence of critical elements of loan determination, and a secured lien is provided from the inception until the distribution of funds, through a SSTP. A monitoring system is included that shows deviation analysis for Claims being processed, so it is possible to pre-adjudicate the claims and the funding advances. A history of the Claims is known, and in fact, each time a transaction goes through, the system gains knowledge.

The present invention capitalizes on recent developments in the law and unites Providers, Payers, and Funding Entities so that, at the point of service, funds can be advanced to the Providers for Claims. The method comprises: receiving a medical expenses Claim for the Claimant; prior to adjudication of the Claim, funding the Provider from the line of credit; collecting payment from the Payer via, for example, an electronic lockbox and electronic settlement; and repaying the line of credit from the collected Payer payment. In alternate embodiments, nonconforming claims (e.g., default claims) can be marketed, liquidated, collected, or sold (e.g., through a bid process).

In an embodiment of the present invention, the CONCERT component includes the following features:

Real-Time Transmission. CONCERT allows customers to utilize a single, real-time Web-enabled interface to conduct Claims-related functions and communications. Response time for the functions and communications is measured in seconds, rather than days or weeks. The transaction is seamless and can be completed before the Patient leaves the office.

Pre-Adjudication. CONCERT is able to assist in providing pre-adjudication of Claims. Thus, when the Provider submits a Claim, CONCERT can tell the Provider if there are any parts of the Claim that do not meet the Payer's contract. In an embodiment of the present invention, pre-adjudication of funding uses a VETS. The VETS feature comprises VETS Criteria Management, which enters values for such factors as Eligibility, Referral Authorization, Ruleset Compliant, and Coding Compliant. VETS Criteria Management continuously validates data to reduce costs, increase accuracy, and lower risk.

Advanced Funding of Claims. CONCERT is also able to support realtime pre-adjudication and advanced funding of Claims prior to Claim approval by the Payers and the Funding Entity. Thus, when the Provider submits a Claim, the Funding Entity can partially (or fully) pay the Claim in real-time based on a risk analysis comprised in the VETS. VETS includes a VETS Funding Percentage, a VETS Provider Rating and Adjustment, and a VETS Payer Rating and Adjustment. Based upon the VETS analysis, the Funding Entity can advance funds to the Provider using a secured line of credit. The present invention is thus able to provide this advanced funding at a lower risk.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

In the drawings:

FIG. 1 presents a pictogram overview of the components and Participants of an example system in accordance with an embodiment of the present invention;

FIG. 2 shows an overview of a method of operation for real-time pre-adjudication and payment in accordance with an embodiment of the present invention;

FIG. 3 displays an exemplary process illustrating how the Claim Check is completed, as set forth in step 230 of FIG. 2;

FIG. 4 displays an exemplary process illustrating how Claim Payment is made and how the Explanation of Benefits (EOB) is sent to the Provider and the Patient, as set forth in step 235 of FIG. 2; and

FIGS. 5-80 are exemplary screen shots of the present invention.

References will now be made in detail to embodiments of the present invention, examples of which are illustrated in the accompanying drawings.

### DETAILED DESCRIPTION

The present invention solves the above needs by providing a method and system for real-time pre-adjudication and payment of medical Claims via a network, such as the Internet. In particular, the present invention relates to a system and method for real-time pre-adjudication, funding, and payment of medical expenses to a Provider for a Claim, the Claim having a Payer, wherein a secured line of credit is established that is associated with the Provider.

The present invention targets the large and growing market of administrative and financial functions involved in the delivery of health care services. It takes advantage of potentially the largest opportunity ever in this very large and very fast growing field. This competitive advantage is sustainable over the long term, based on the present invention providing the capability to expand the Medical Highway functionality. The greater the amount of data aggregated, the greater the “intelligence” and the decision support possible. By using the present invention, it is estimated that a 50% potential cost savings can be reached in submission, adjudication and payment of health care Claims.

System Overview

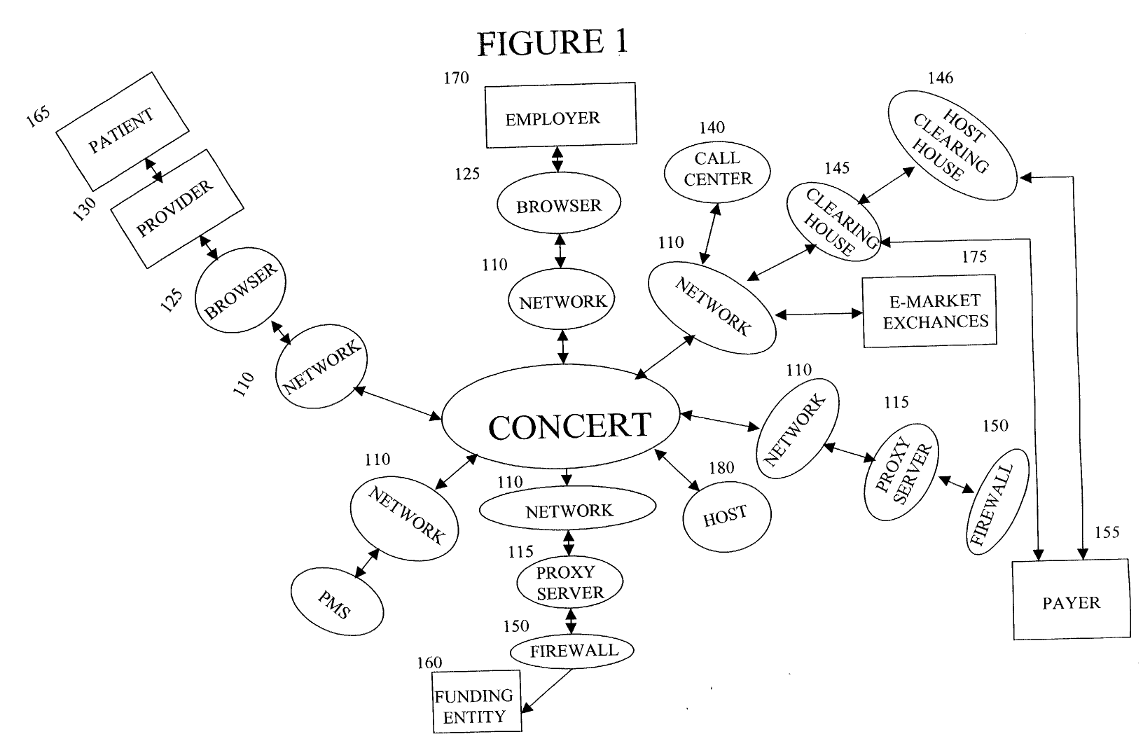

FIG. 1 presents a pictogram overview of the components and Participants of an example system in accordance with an embodiment of the present invention. The components include a Practice Management System (PMS) (referred to interchangeably herein as CONCERT) 120, an Intemet/VPN 110, a Proxy Server 115, Browsers 125, Interfaces 135, a Call Center 140, a Clearing House 145, and Firewalls 150. The Participants include: Providers 130, Payers 155, Funding Entities 160, Patients 165, Employers 170, E-Market Exchanges 175, and a Host 180.

In the present invention, the Patient 165 goes to the Provider 130 for services. The Provider 130 submits a pre-Claim to the Host 180. Once the pre-Claim has been approved, the Provider 120 treats the Patient 165. The Provider then submits a Claim for pre-adjudication. The Claim is pre-adjudicated and, assuming the Claim meets required criteria, the Provider 120 is given advanced payment for the Claim.

Components

Each of the components will now be described in further detail.

PMS (CONCERT). Practice Management Systems (PMS) 120 facilitate information flow. In one embodiment of the present invention, Claims Online Network Clearing Exchange in Real-Time (CONCERT) has the ability to interface with one or more PMS (e.g., the PMS of IDX). CONCERT 120 provides a real-time medical highway that addresses the Claim processing cost crisis in health care. CONCERT 120 provides a secure network that facilitates the real-time transmission, pre-adjudication, and advanced payment of Claims. CONCERT 120 provides interactive collaboration for the Payer 155, the Provider 130, and the Funding Entity 160, with minimal, or no, up front costs.

In an embodiment of the present invention, CONCERT 120 comprises the following features:

Real-Time Transmission. CONCERT 120 allows customers to utilize a single, real-time Web-enabled or other networked interface to conduct Claims-related functions and communications, including real-time decision support tools. These functions include Claims submission, adjudication, payment and Claims accounting, Claims status, medical service eligibility, pre-certification, Claims scrubbing, physician referral authorization, Explanation of Benefits (EOP) reconciliation, and advancement of funds. In one embodiment of the present invention, CONCERT 120 uses an ASP model that incorporates quality-of-service controls, security, and high-speed transport that allows the Participants to take advantage of resources that otherwise would be beyond their budget reach. Response time for the functions and communications is measured in seconds, rather than days or weeks. The transaction is seamless and can be completed before the Patient 165 leaves the office. The present invention is discussed in the context of the communication being performed through a network and a terminal (e.g., email), but the communication can also be conducted by facsimile, telephone, handheld device, etc., or any combination of these.

Pre-Adjudication. In one embodiment of the present invention, CONCERT 120 is able to support pre-adjudication of Claims and funding. Thus, when the Provider 130 submits a Claim, CONCERT 120 can tell the Provider 130 if there are any parts of the Claim that do not meet the Payer's contract. Pre-Adjudication uses a VETS. The VETS component comprises VETS Criteria Management, which enters values for Eligibility, Referral Authorization, Ruleset Compliant, and Coding Compliant. VETS Criteria Management continuously validates data to reduce costs, increase accuracy, and lower risk.

Advanced Funding of Claims. CONCERT 120 is also able to support realtime advanced funding of Claims prior to Claim approval by the Payers 155. Thus, when the Provider 130 submits a Claim, the Funding Entity 160 can partially (or fully) pay the Claim in real-time based on a risk analysis comprised in the VETS. VETS includes a VETS Funding Percentage, A VETS Provider Rating and Adjustment, and a VETS Payer Rating and Adjustment. Based upon the VETS analysis, the Funding Entity 160 can pay the Provider 130 and provide the Payer 155 a line of credit. The present invention is able to provide this advanced funding at a lower risk because: 1) The revised Article 9 provision of the Uniform Commercial Code 1 (UCC 1) law allows the Funding Entity 160 to take a secured interest in the Payer 155; 2) It is easier to comply with all the regulations of the medical industry (including HIPPA and Gramm-Leach-Bliley); and 3) The Claim status can be monitored on a continuing basis, so there is early warning of Claims not conforming to past history, and action can be taken quickly.

Internet/VPN. The Internet 110 is a worldwide collection of networks and gateways that communicate with each other. The VPN 110 is a set of nodes on a public network such as the Internet that communicates among themselves using encryption technology so that their messages are as safe from being intercepted and understood by unauthorized users as if the nodes were connected by private lines.

Proxy Server. The Proxy Server 115 is a Firewall 150 component that manages traffic on the Internet to and from a Local Area Network (LAN). The server includes, for example, one or more personal computers (PCs), minicomputers, microcomputers, or mainframe computers.

Browser. The Browser 125, also referred to herein interchangeably as a Graphical User Interface (GUI) is software that lets a user view HyperText Markup Language (HTML) documents and access files and software related to those documents.

Interface. The Interface is the point at which a connection is made between CONCERT 120 and the Local Area Network-Wide Area Network (LAN-WAN) so that they can work with each other or exchange information.

Call Center. The Call Center 140 provides support and answers for office staff for questions and/or problems they may have with respect to the products and their use.

Clearing House. The Clearing House 145 can be a Host Clearing House that connects directly to the Payer, or a traditional Clearing House that the Host uses to connect to the Payer. The Clearing House 145 can aggregate the Providers' EDI Claims for volume clearing house-pricing advantage. It provides a single source for the Provider Claims clearing that reduces the expense of administration by providing volume discount factors.

Firewall. The Firewall 150 is a security system intended to protect an organization's network against external threats, such as hackers, coming from another network, such as the Internet.

Participant Computers. Each of the Participants described below (Providers 130, Payers 155, Funding Entities 160, Patients 165, Employers 170, and E-Market Exchanges 175) has a computer or other terminal coupled to CONCERT 120. This coupling includes, for example, wired, wireless, or fiberoptic links. Send terminals include, for example PCs, minicomputers, microcomputers, mainframe computers, telephone devices, handheld devices, and other devices using a processor and display.

It should be noted that the capabilities of the system of an embodiment of the present invention depend on user hardware and access selections. In an embodiment of the present invention, with one option, locally loaded software at a user'sterminal, such as a personal computer (PC), minicomputer, microcomputer, mainframe computer, telephone device, hand-held device, or other device with a processor and capability of connecting to a network, is used to access the network via coupling. With a second option, the user utilizes a network browser on the user's terminal to access the system. database via, for example, a network site hosted by a server. Other embodiments will be obvious to those familiar with the art.

Participants

The Participants, in accordance with an embodiment of the present invention include the following:

Host. The Host 180 runs CONCERT 120 to facilitate the communication and information-sharing of all the Participants.

Providers. The Providers 130 see the Patients 165, refer the Patients 165, perform procedures, and order medical supplies and medications. In order to successfully market to the Providers 130, the present invention can provide an easy to use format. The Providers 130 receive an immediate funding of Claims, a reduced risk of fraud or lack of compliance, an increase in back-office efficiency, and a cost reduction with an ASP-based practice management system and/or Application Program Interfaces (APIs) to other practice management systems that provides a full range of integrated business services. These business services include real-time eligibility, authorization, Claims status, electronic EOP, and a greatly enhanced financial position due to the ability to leverage accounts receivable assets and provide judgment proof protection.

Payers. The Payers 155 can outsource all Claims processing or fraud detection to CONCERT 120. For those Providers 130 with an advanced payment option, a line of credit is established with a Funding Entity 160 at a favorable interest rate. Monies received from the Payer 155 for Claims are directed into a pres-established account (sometimes called a CashLink account) to repay the principal on the line of credit. Signing up local or regional Payers 155 that control a large percentage of the insured lives is a benefit of the present invention. By providing cost saving functions to their highest volume Providers 130, Payers 155 begin to realize significant cost savings. As a result, Payers 155 encourage Providers 130 to consider a system that may save the Payer 155 75% of his processing costs. Even though there are approximately 17,000 national health care Payers 155, there are about 300-400 that control 80% of the Patient/Provider base.

Funding Institutions (Funding Entities). The Funding Entities 160 (e.g., banks or other financial institutions) receive: an increased revenue by combining high quality loan volume with significant risk reduction; a material transactional cost reduction; and an enhanced ability to develop financial services (private banking) and to retain and grow its preferred customer base. The Funding Entities 160 provide immediate liquidity to the Providers 130. The Funding Entities 160 are attracted by: 1) the increase in core deposits; 2) the increased revenue from high quality loans; 3) the ability to develop fee income from private banking services; and 4) a reduced regulatory capital commitment to support outstanding loans through risk management. Advance payments on Claims are funded from a pre-approved line of credit. Automatic, real-time decision support for Claims processing, adjudication, and payment is an excellent product for Funding Entities 160 to, for example, enhance their relationship banking advantage.

Patients. The Patients 165 have immediate access to the Claims settlement process. Patients 165 are Internet-enabled and empowered to make informational inquiries of both Providers 130 and Payers 155 prior to the settlement process.

Employers. The Employers 170 can be allowed to become part of the Claims adjudication process. The Employers 170 have the ability to perform on-line enrollment, monitor Patient/Employee satisfaction, and participate and review in the financial process of Claims settlement and contract compliance.

E-Market Exchanges. The E-Market Exchanges 175 empower the Providers 130 by aggregating procurement volume and pre-approved credit facilities to offer “Reverse Auction” proposals to pre-qualified vendors. The “Click/Rap” functionality greatly reduces the transaction cost and fulfillment time necessary to deliver the select product or service. One focus of the present invention surrounds non-mission critical products and services such as office supplies, training and printing. By using Online Relationship Banking Integration Technology (ORBIT) function ability, enhancements of pre-approved credit facilities are made possible, as well as real-time interfacing with the Providers 130 and Funding Entities 160 who can customize credit products for specific offerings.

Method Overview

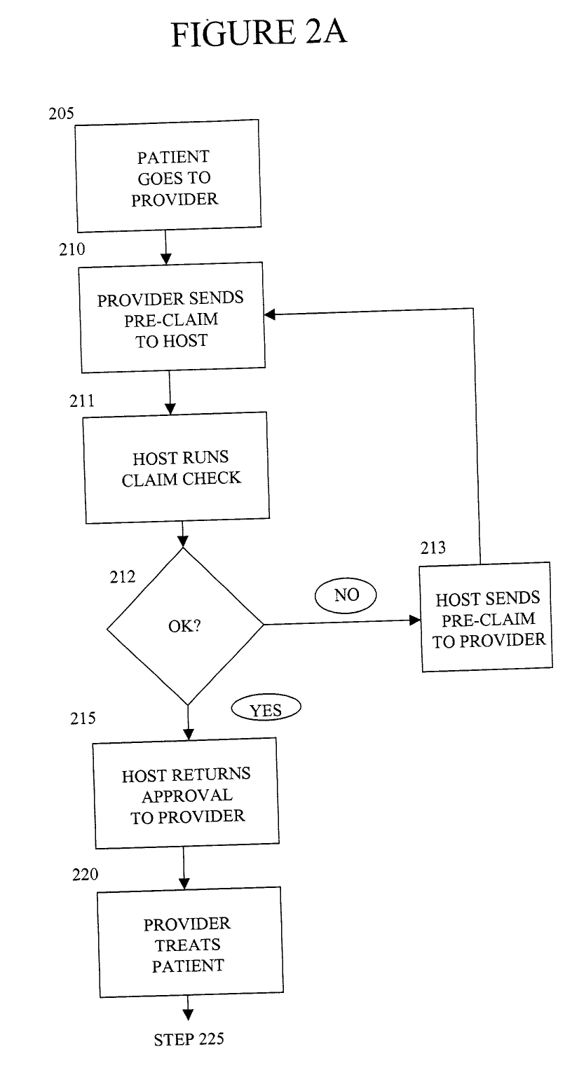

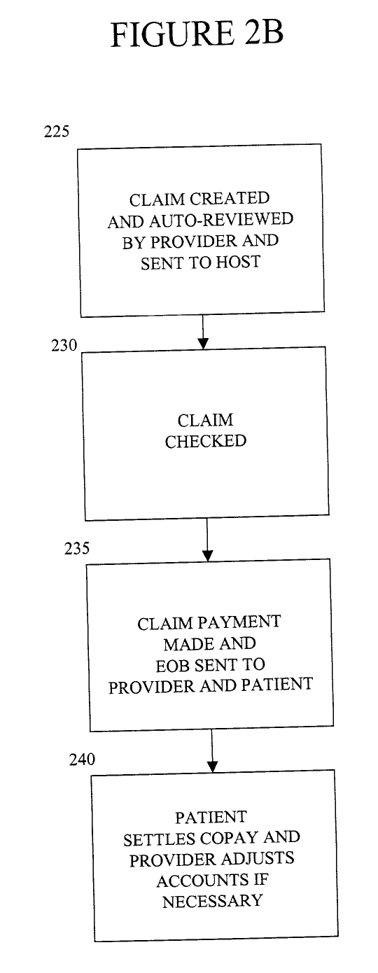

FIGS. 2A and 2B show an overview of an example scenario for a method of operation for real-time pre-adjudication, funding and payment in accordance with an embodiment of the present invention.

As shown in FIG. 2A, in step 205, the Patient 165 goes to the Provider 130 for services.

In step 210, the Provider 130 sends a Pre-Claim to the Host 180.

In step 211, the Host 180 runs a Claim Check to test Claim data against historical data. In an embodiment of the present invention, this is done using CONCERT's VETS Criteria Management. The Pre-Claim Check determines, for example, if the Provider 130 is in the Patient's Health Plan, and comprises a Patient's identification, eligibility and/or referral information. The Claim data includes physician statistical data that enables comparison and/or trending of intergroup physician productivity, physician compliance with evaluation and management guidelines, coding evaluation, and outcome analysis.

In step 212, it is determined if the Claim Check meets predetermined criteria. If it meets the criteria, the Host 180 returns such indication online and in real-time in step 215. If it does not meet the criteria, the process moves to step 213, where the Host 180 sends the Pre-Claim back to the Provider 130 to edit or otherwise review thereby providing real-time decision support tools. The process then moves to step 210 and is repeated.

In step 220, the Provider 130 sees the Patient 165 for medical care and treatment.

In step 225, the Provider 130 creates the Claim, reviews it for completeness and correctness, and sends it to the Host 180. The review can be performed, for example, using CONCERT's VETS Criteria Management.

In step 230, a Claim Check is performed. The Claim Check determines if the Claim conforms to preestablished criteria, and the Claim payment request is approved or denied, thereby providing another example of real-time decision support tools. During the Claim Checking Process, the Payer 155, Provider 130, and Funding Entity 160 have access to interactive editing capabilities, such as revising price, bundling, funding approval, and funding amount.

In step 235, once the Claim Check is performed and approved, the Funding Entity 160 issues a Claim Payment, and the Payer 155 is notified.

In step 240, the Patient 165 settles all required co-payments, etc., and all financial transactions are posted to the appropriate accounts automatically.

Claim Check

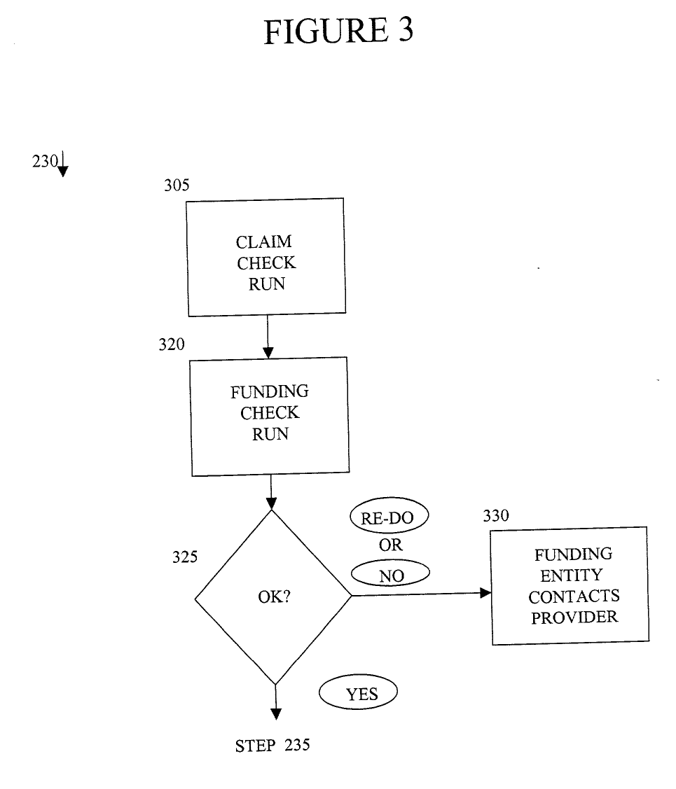

FIG. 3 displays an exemplary process illustrating how the Claim Check is completed, as set forth in step 230 of FIG. 2.

In step 305, a Criteria Claim Check is performed. This is done using the VETS Criteria Management. (For example, if the Provider 130 has entered a code as a level 4 Claim ($1000), and the Payer's contract says that Claim is a level 3 Claim ($750), then the Provider 130 is notified that there is a difference and has the chance to edit or otherwise respond to the notification. In response, the Provider 130 can, for example, leave the claim at a level 4, and submit the Claim knowing it may be further scrutinized, or the claim could be changed to a level 3.

Once the Claim passes the Claim Check, a Funding Claim Check is performed in step 320. The Funding Claim Check is a real-time comprehensive analysis, based on the VETS Funding Percentage, VETS Provider Rating and Adjustment, and VETS Payer Rating and Adjustment, which reviews the Claim based on the Funding Entity's funding or loan processing formula. This is where the credit rating and funding eligibility of the Payer 155 is ascertained. Based on the Funding Claim Check, the Funding Entity 160 decides to: 1) approve Advanced Claim Funding; 2) reject Advanced Claim Funding; or 3) re-calculate Advanced Claim Funding. (Both Compliant and Non-Compliant Claims, can be considered for advanced funding).

In an embodiment of the present invention, the Provider 130 and the Funding Entity 160 have established a trusted agent relationship through a B CASHLINK Agreement, which provides a trusted agent relationship with the Provider 130. The Provider 130 and the Host 180 also have signed, for example, a legally binding agreement that establishes a Trusted Agent Relationship.

In step 310, it is determined if the Funding Entity 160 approved, rejected, or recalculated the Claim Funding with the Claim amount deposited. If APPROVED, the process moves to step 235 of FIG. 2. If REJECTED, the process moves to step 330, where the Funding Entity 160 contacts a Relationship Manager who in turn contacts the Provider 130. This is another example of the use of the real-time decision making support tools. If RE-CALCULATED, an exception formula is provided to the Relationship Manager. The Relationship Manager accepts or reports the exception formula, with an option to communicate with the Provider 130.

Claim Payment and Forwarding of EOB

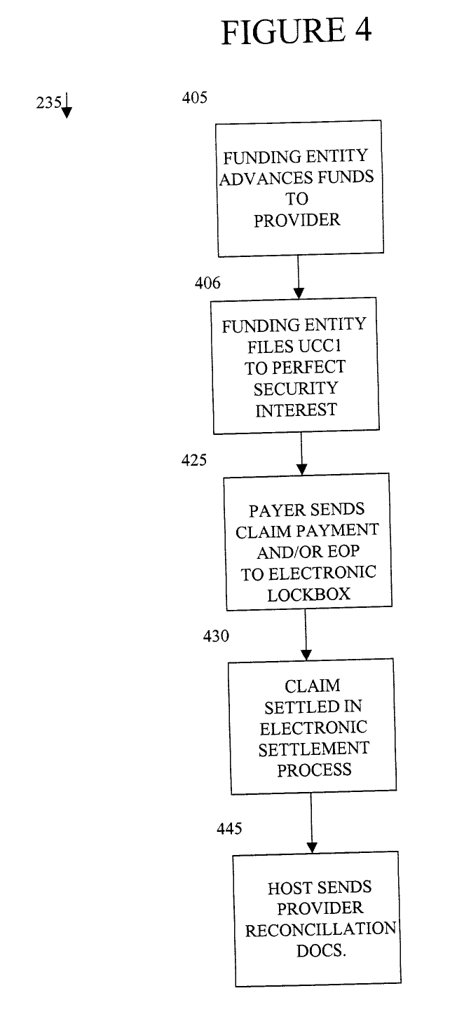

FIG. 4 displays an exemplary process illustrating how Claim Payment is made and how the Explanation of Benefits (EOB) is sent to the Provider 130 and the Patient 165, as set forth in step 235 of FIG. 2.

In step 405, the Funding Entity 160 advances funds to the Provider 130 from the Payer's line of credit.

In step 406, the UCC1 is filed or perfected by, for example, the Funding Entity 160. A blanket UCC1 filing provides a secured interest in the Claim (and all other existing and future Claims from the Provider 130). To support the filing of the UCC1, the Funding Entity 160 reviews the Provider's articles of incorporation, and determines the precise legal name of the Provider 130, and where the Provider 130 resides. The Funding Entity 160 collects and maintains this information, along with proof that the claim transaction has taken place.

In addition to the benefit of a secured interest, in an embodiment of the present invention, the Funding Entity 160 has control of the disbursement process because the Payer 155 must send the Claim proceeds to a lockbox that is subject to the UCC1 filing using a secure mechanism, such as an “electronic lockbox”, as discussed in more detail below. (Note: “electronic lockbox” is used interchangeably herein with other descriptions of the secure mechanism for such payments and exchanges.)

In an alternative embodiment, the UCC1 also facilitates the involvement of the E-Market Exchanges 175. The UCC1 filings make it easy to make a legal claim based on the security interest in the event of default. Because of the secured nature of the credit and the digitized collateral supporting documentation for whole claims or partial claims can be bought and sold and/or asset securitized on the market.

In step 425, the Payer 155 sends the Claim Payment and Explanation of Payment (EOP), using, for example, an electronic lock box, to the Funding Entity 160, and notifies the Host 180. The Provider 130 is then responsible, for example, for collection of any payment, such as the copayment, due from the patient.

In step 430, the Claim is settled electronically in an Electronic Settlement Process, and the Payer's Claims disbursement and settlement dollar amount is compared to the Payer's EOP instructions. The funds in the Electronic Lockbox are disbursed to the Funding Entity 160. The principal and interest on the advanced funded amount, the Host fees, and other fees or amounts are reconciled and verified and disbursement instructions are prepared. Any remaining funds owed to the Provider 130 are dispersed according to the Provider's Standing Orders of Instruction (SOI). All funds disbursements are subject to the Funding Entity's UCC1 lien. If available funds are insufficient to repay the Provider'sobligations to the Funding Entity 160, funds will not be disbursed until the secured UCC1 liens are satisfied. Reconciliation documents can include a Transaction Memorandum. The Transaction Memorandum details such information as the following: the Settlement Term Sheet details, the amount already paid to the Provider 130, additional fees (if applicable), interest on the line of credit, and the net remainder owed to the Provider 130. (In an alternative embodiment, the interest on the line of credit can be paid by the Provider 130, unless, for example, the Payer 155 is over the Payer's legal time limit. In this case, the Payer 155 would pay the interest accrued past the Payer's legal time limit.) The Settlement Term Sheet details such information as the following: disbursement instructions; general ledger entries to settle the loan; the release of the UCC1 filing; a Host user fee; and Provider net proceeds.

In step 445, the Host 180 sends the reconciliation documents, such as the Transaction Memorandum, to the Provider 130 in real-time so that the Provider 130 can reconcile its accounts. The Host 180 can post the reconciliation documents to the Host's PMS system or to a 3rd party PMS system, or the Host 180 can notify the Provider using some other method.

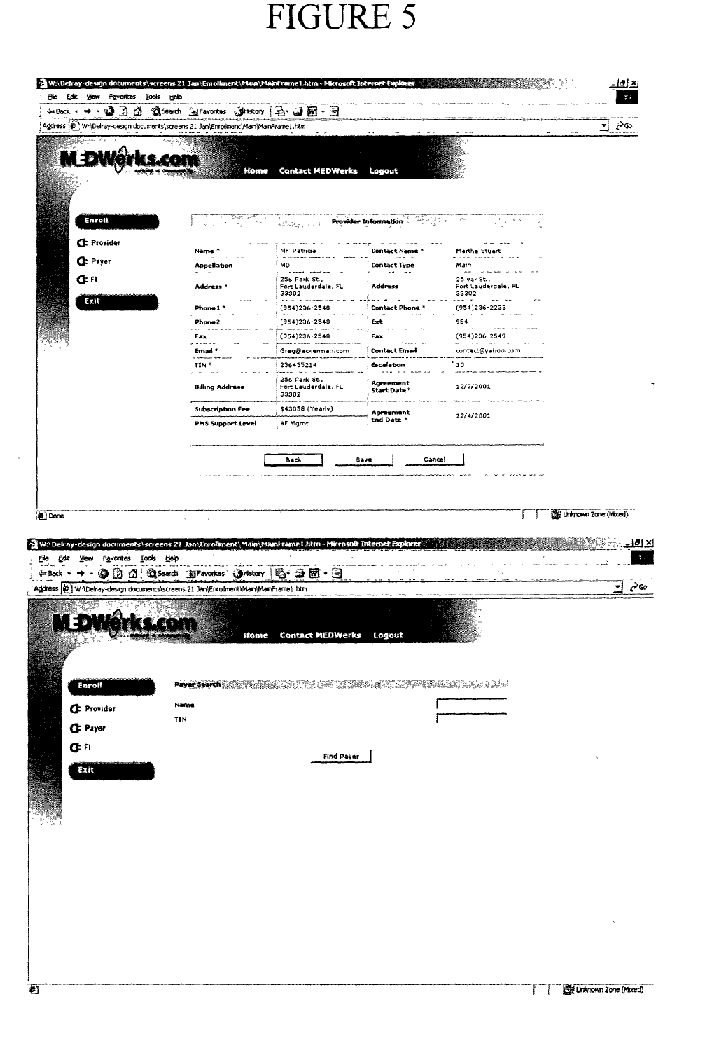

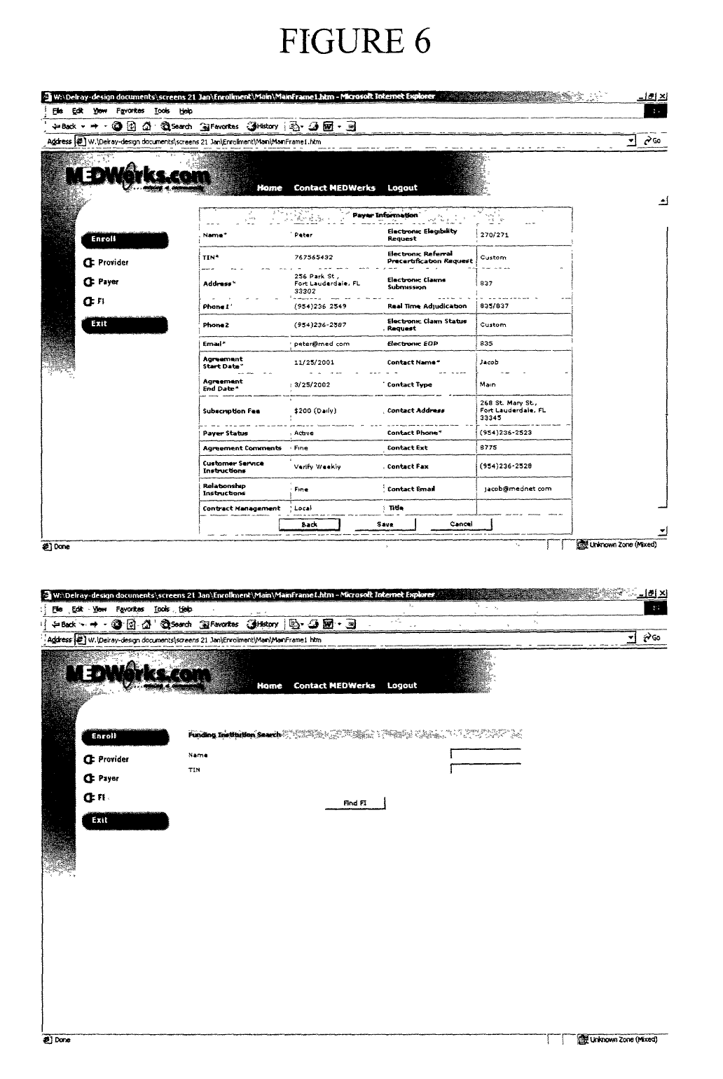

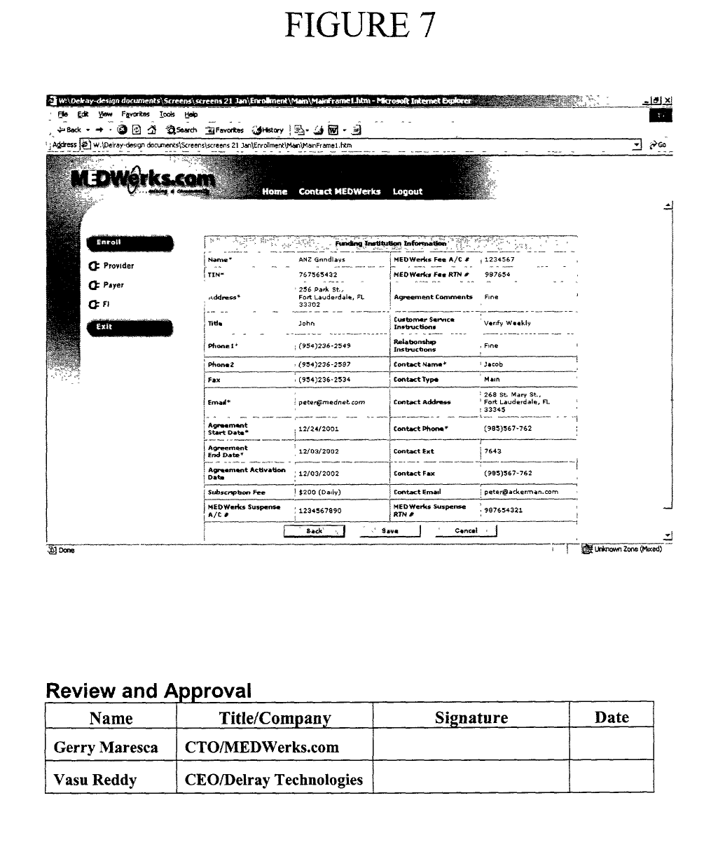

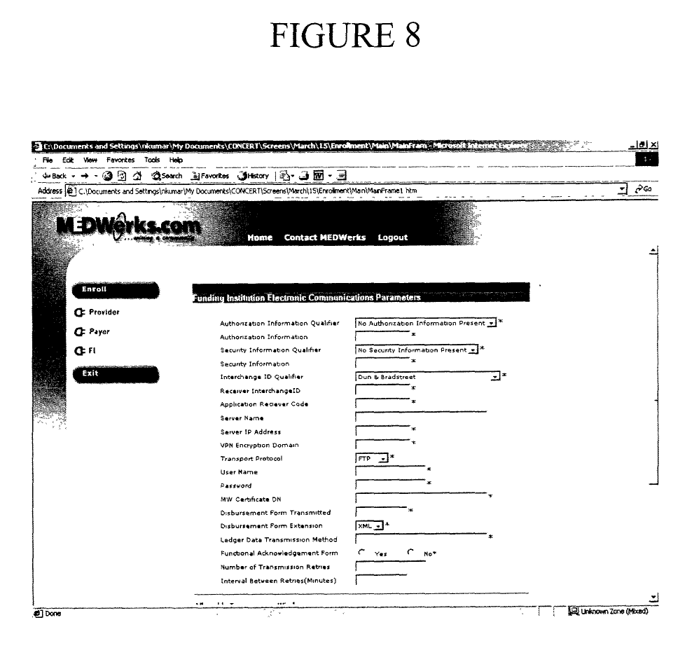

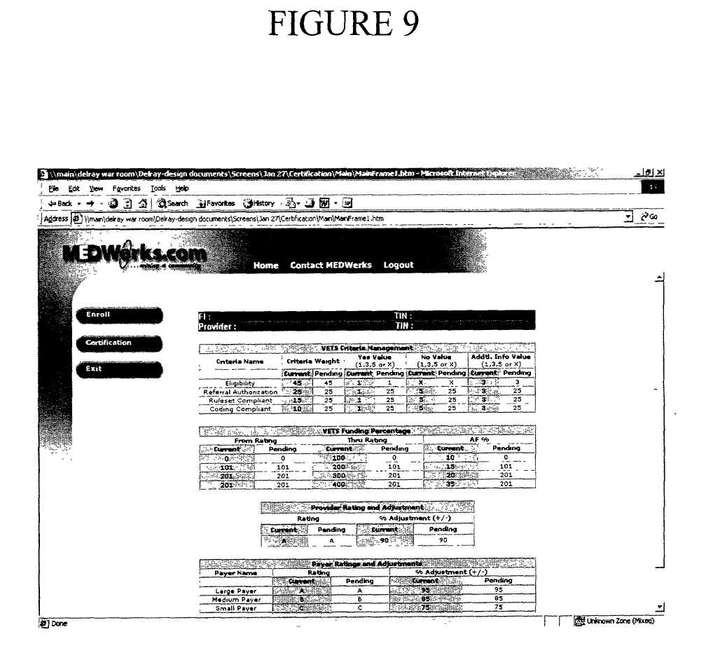

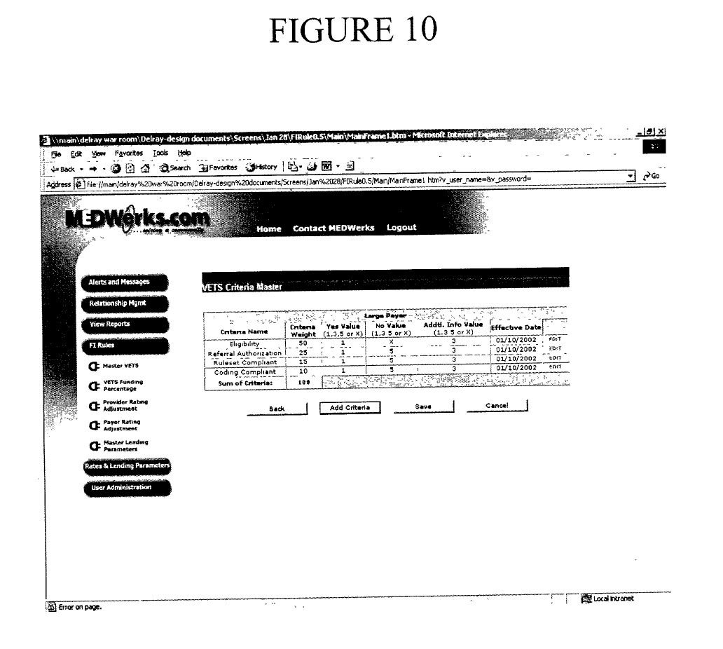

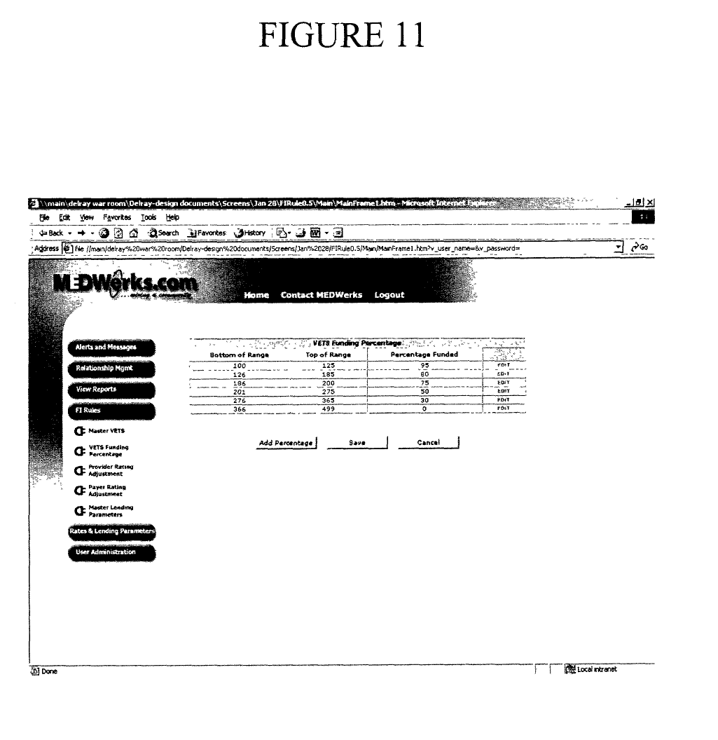

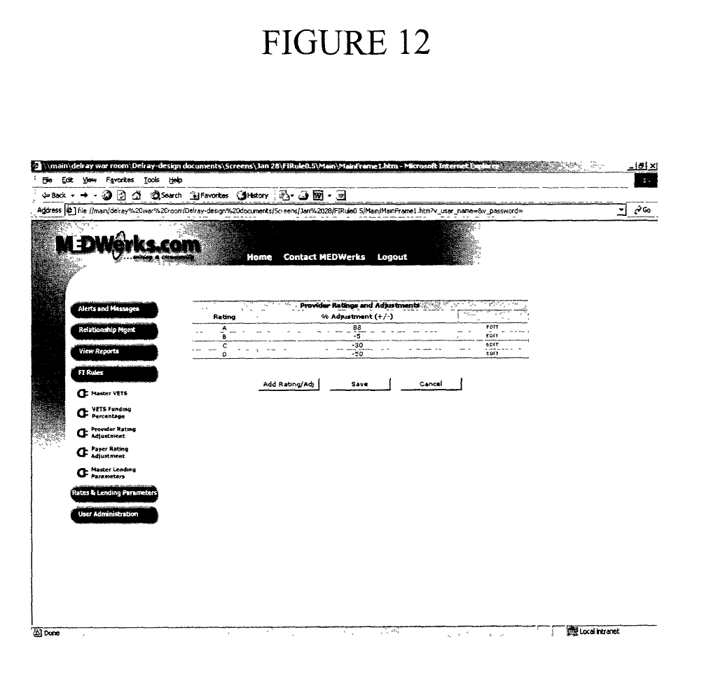

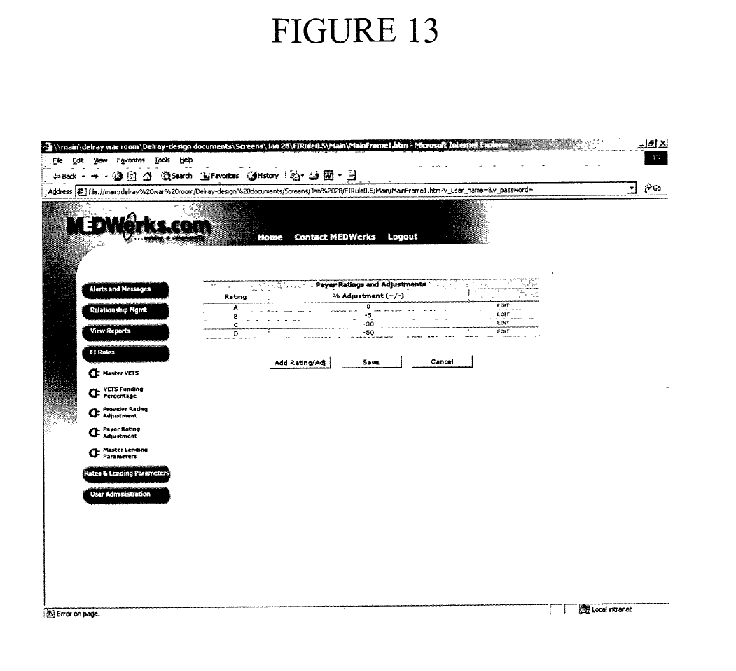

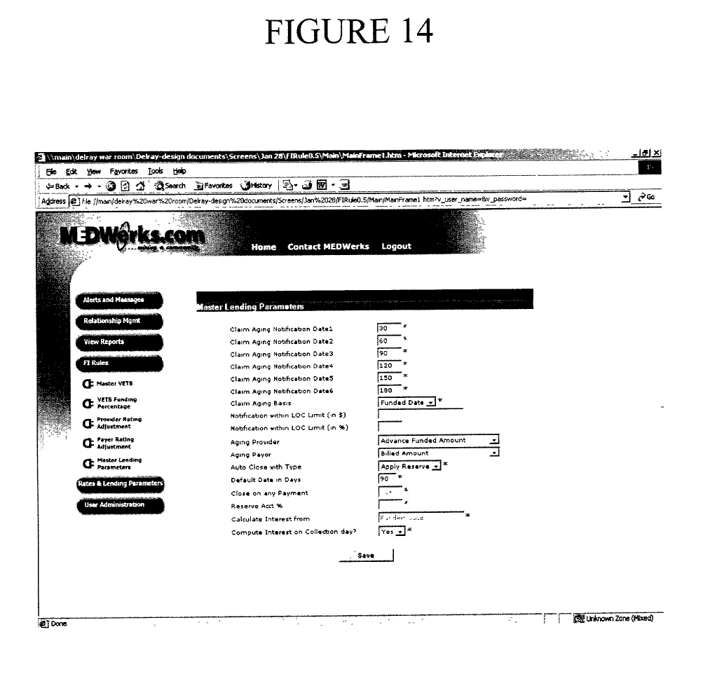

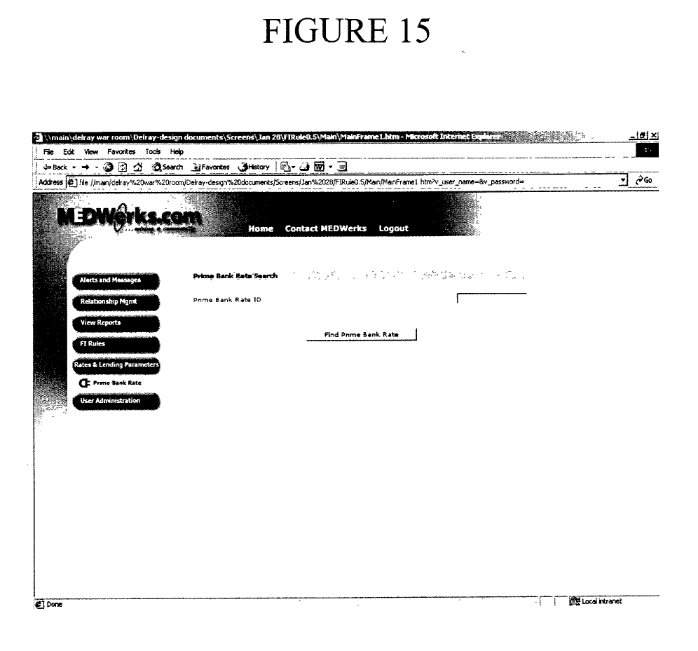

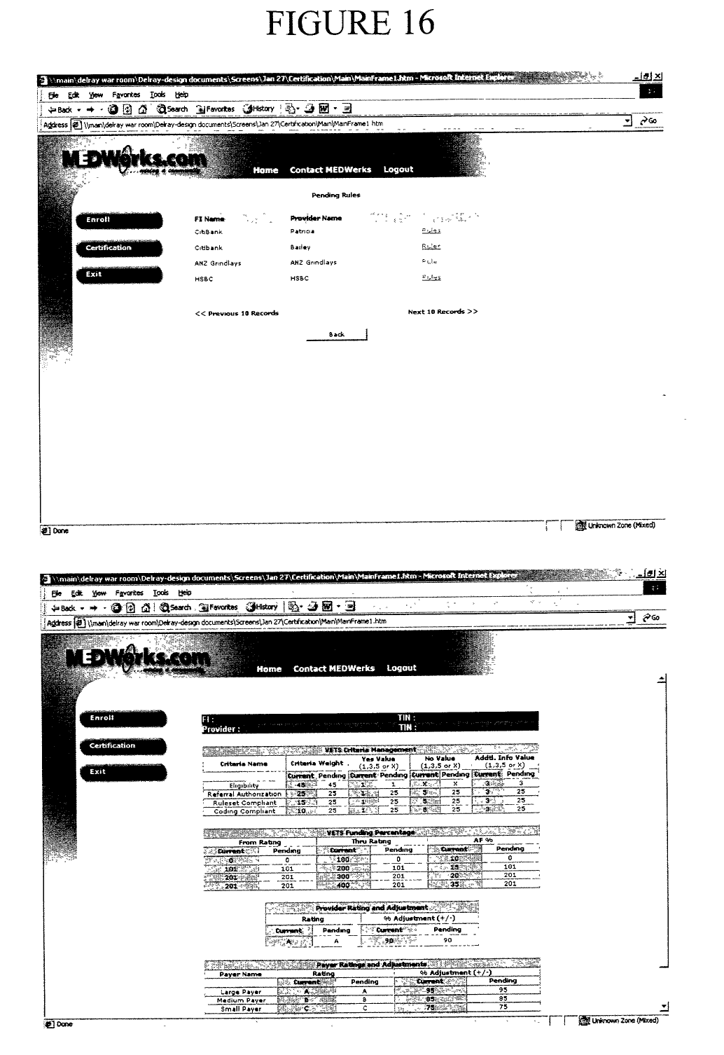

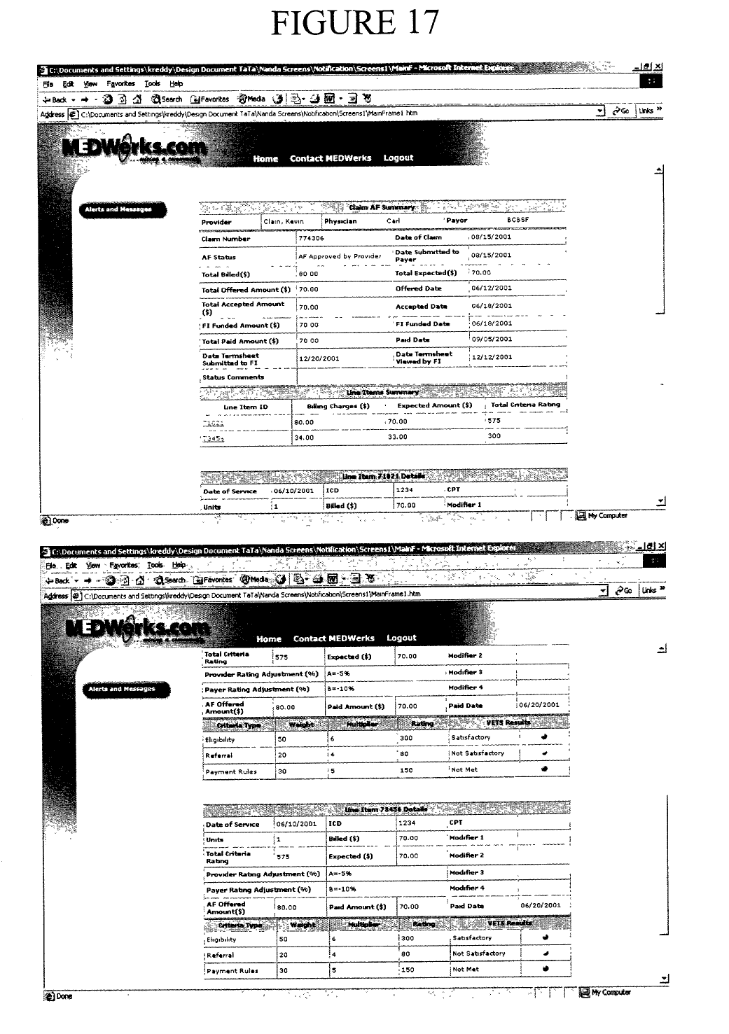

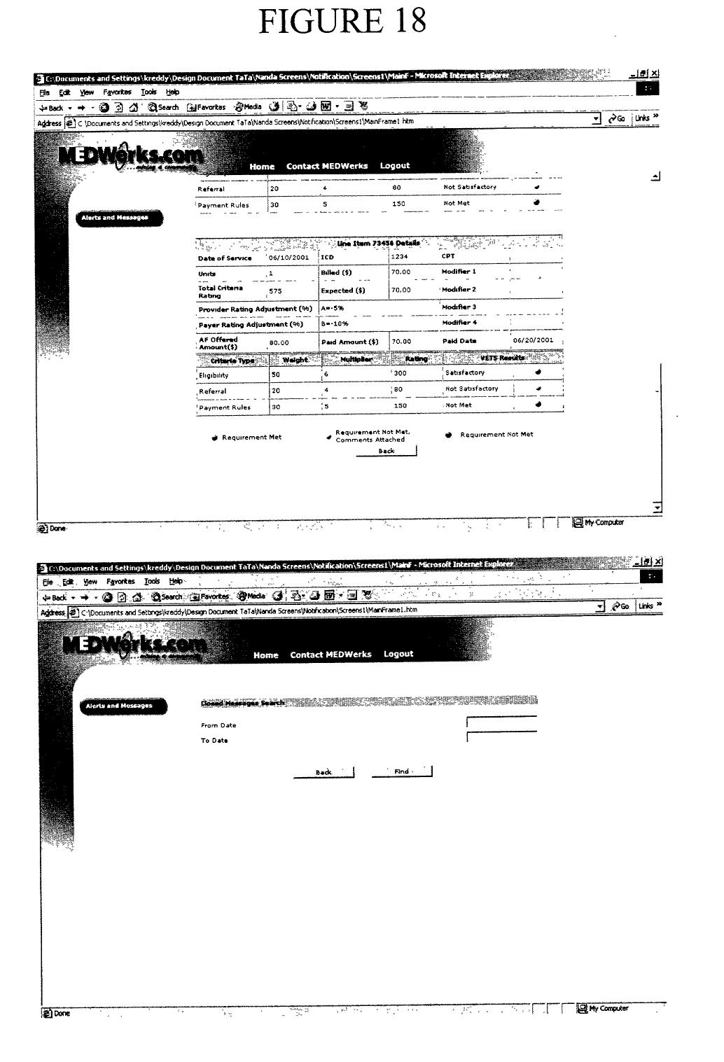

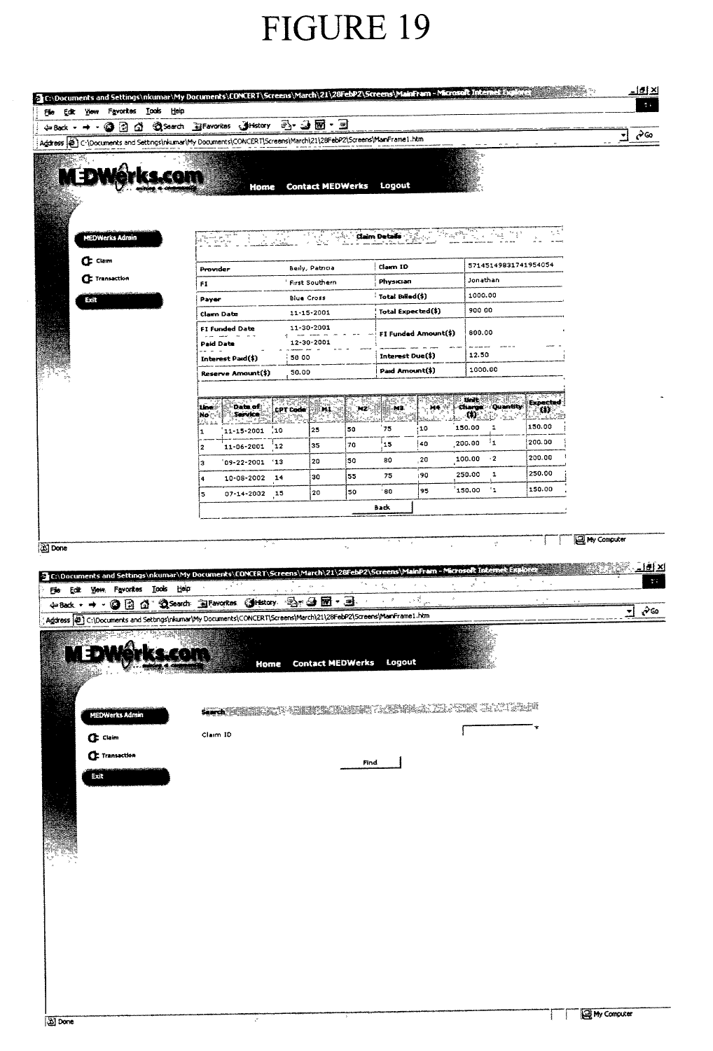

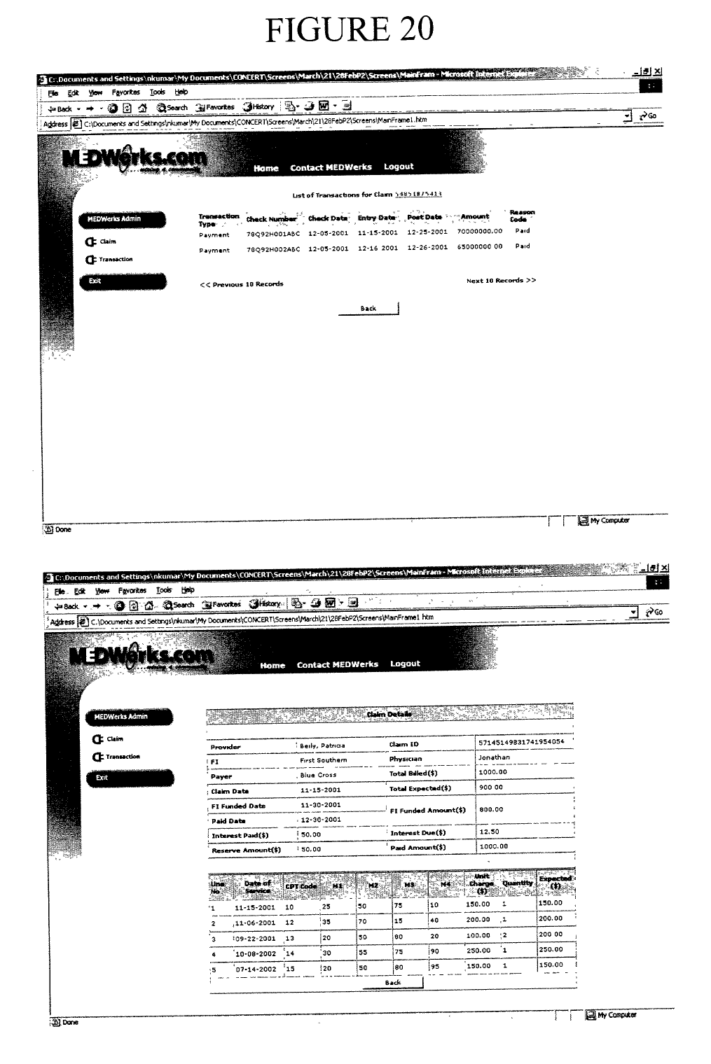

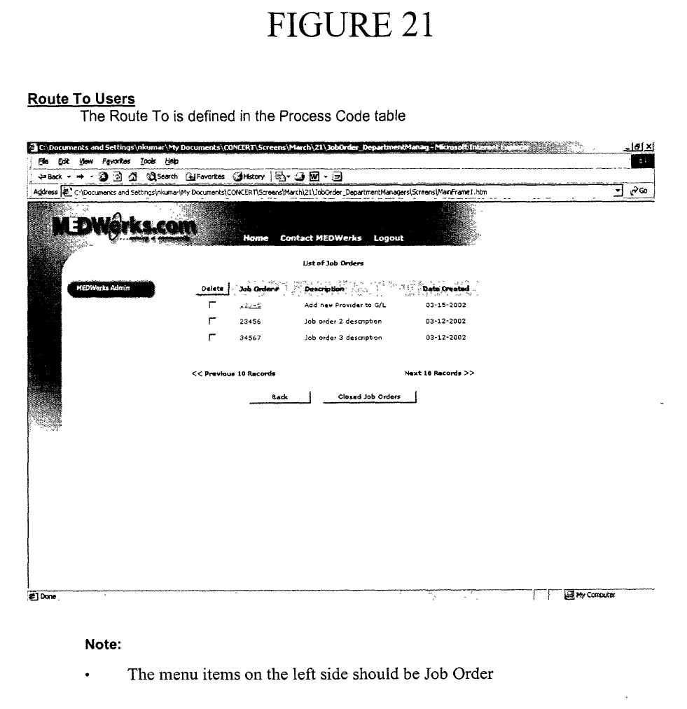

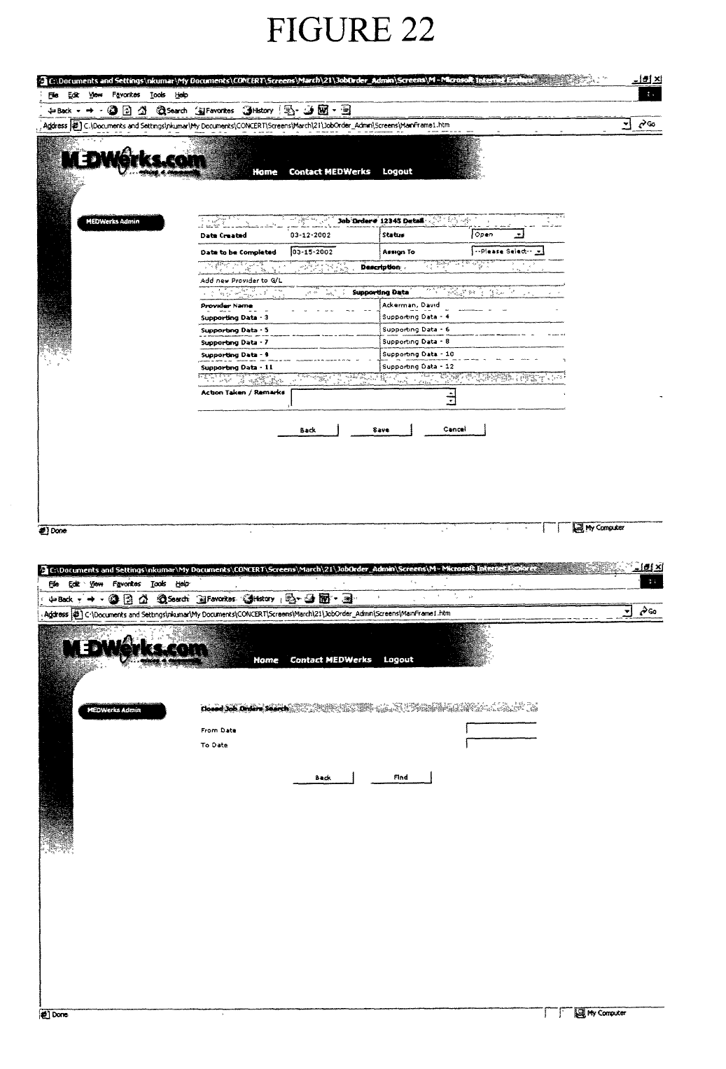

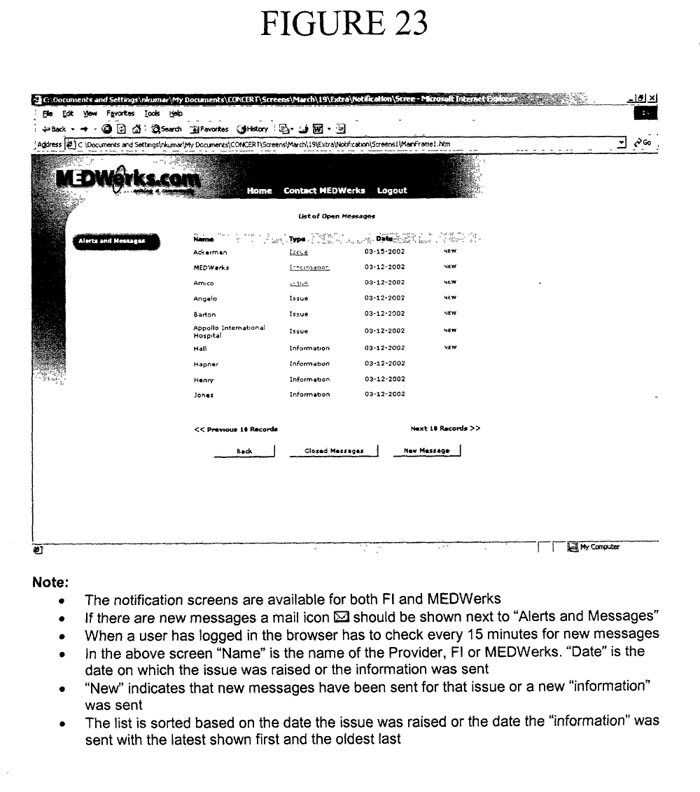

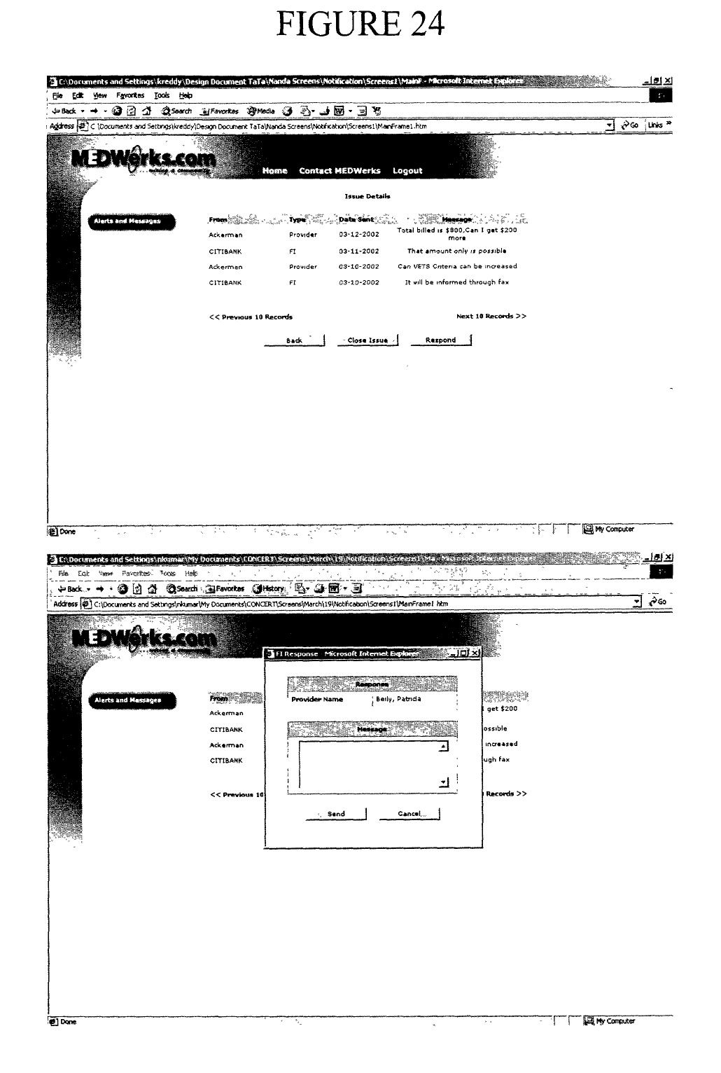

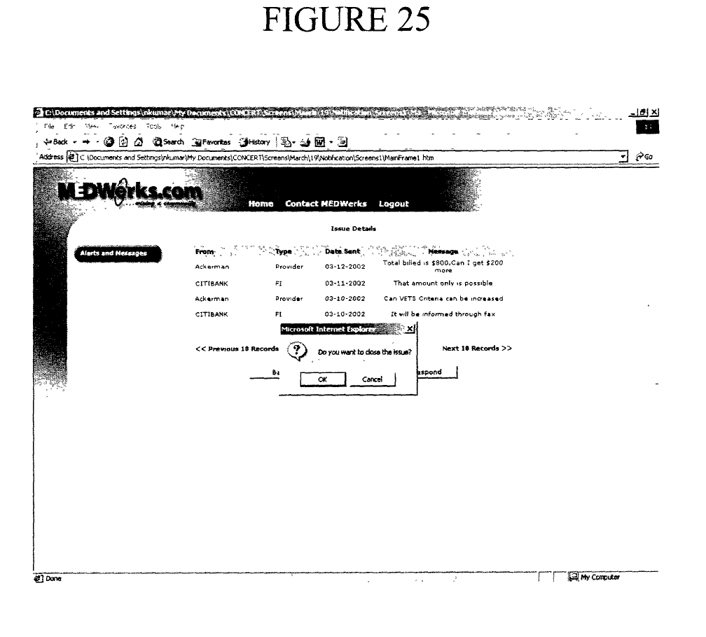

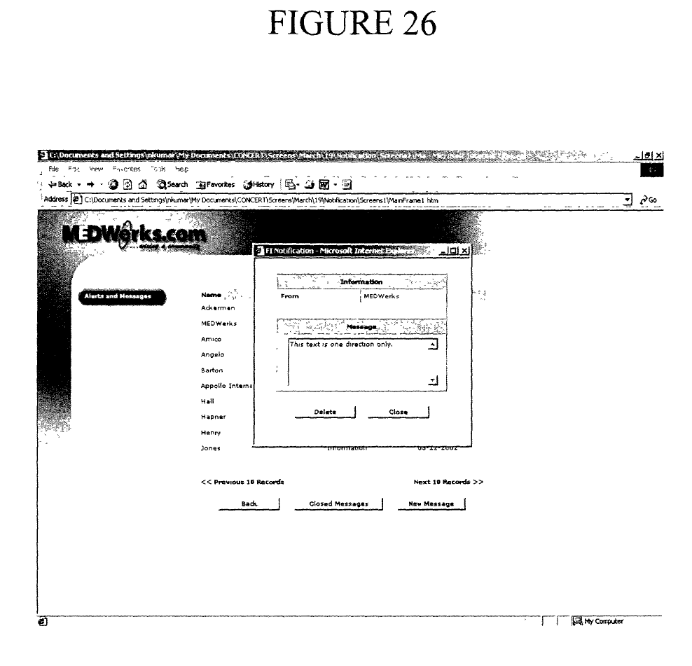

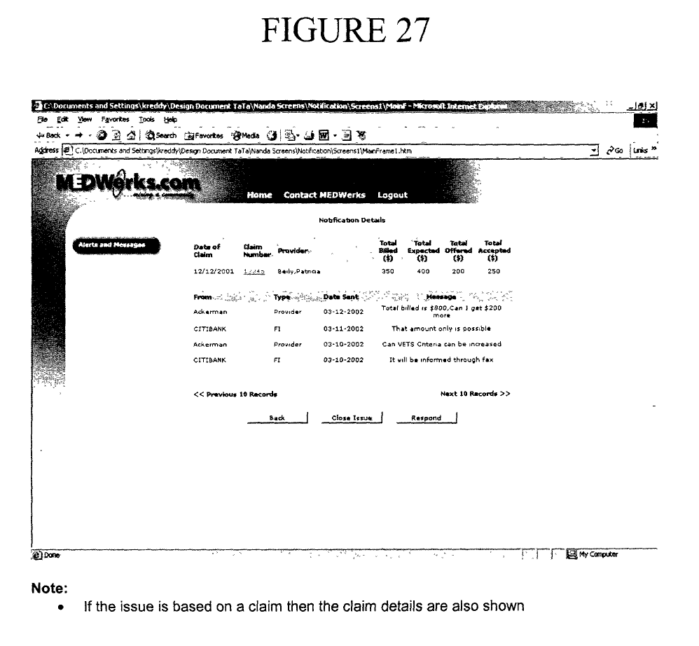

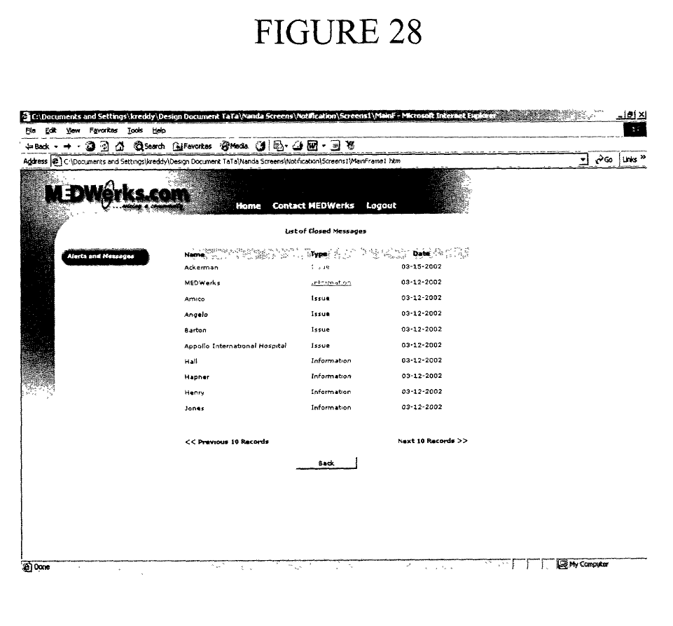

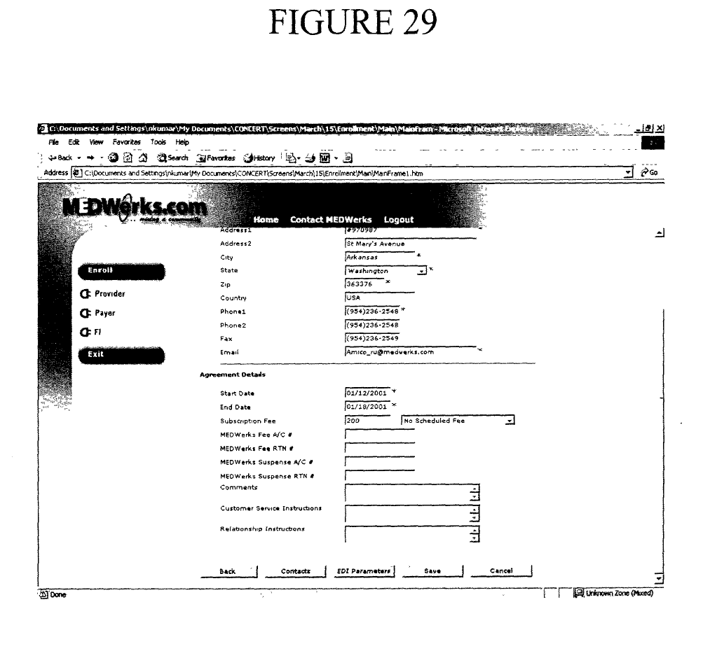

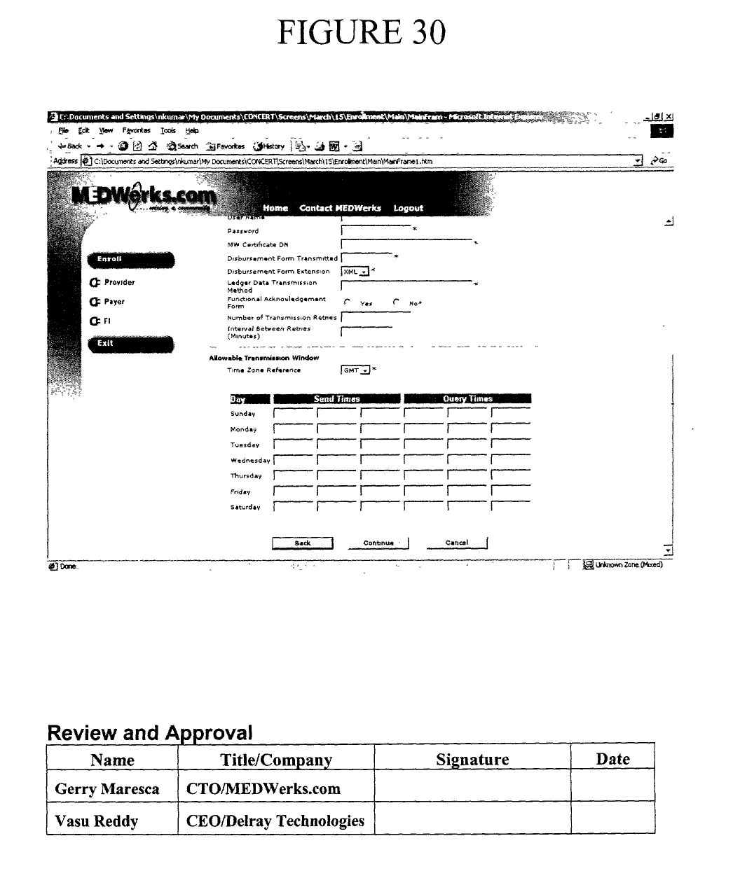

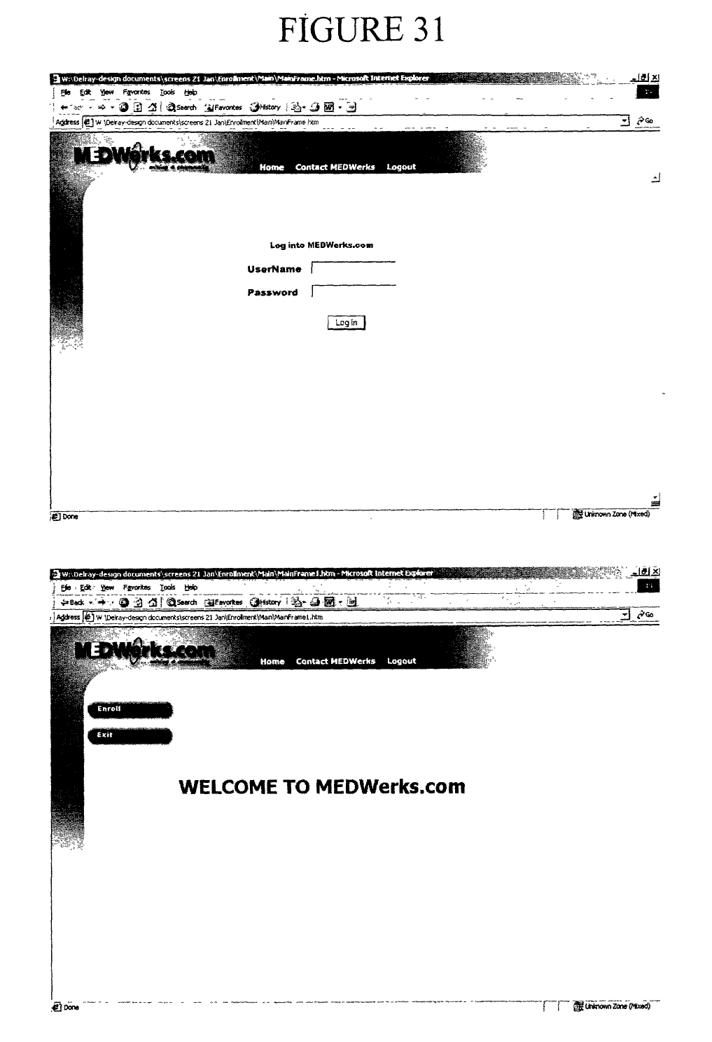

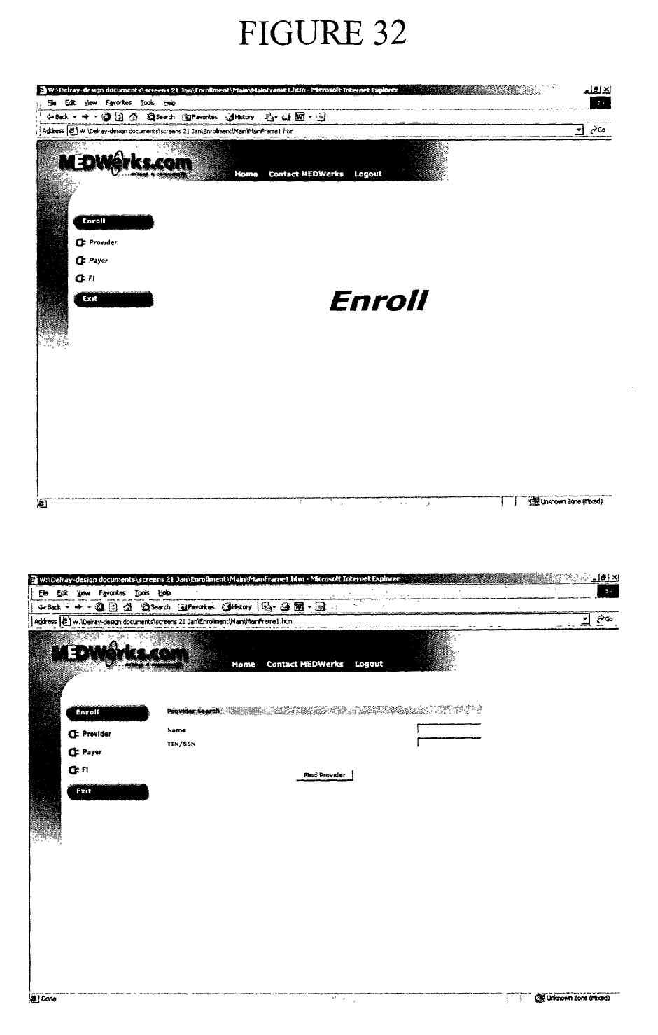

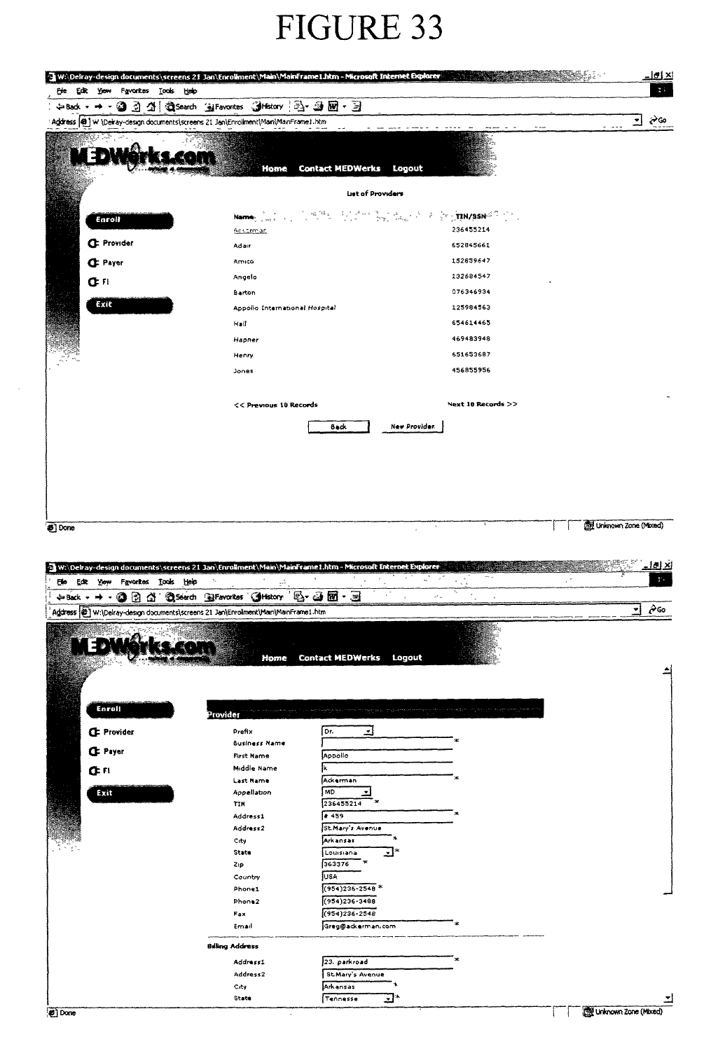

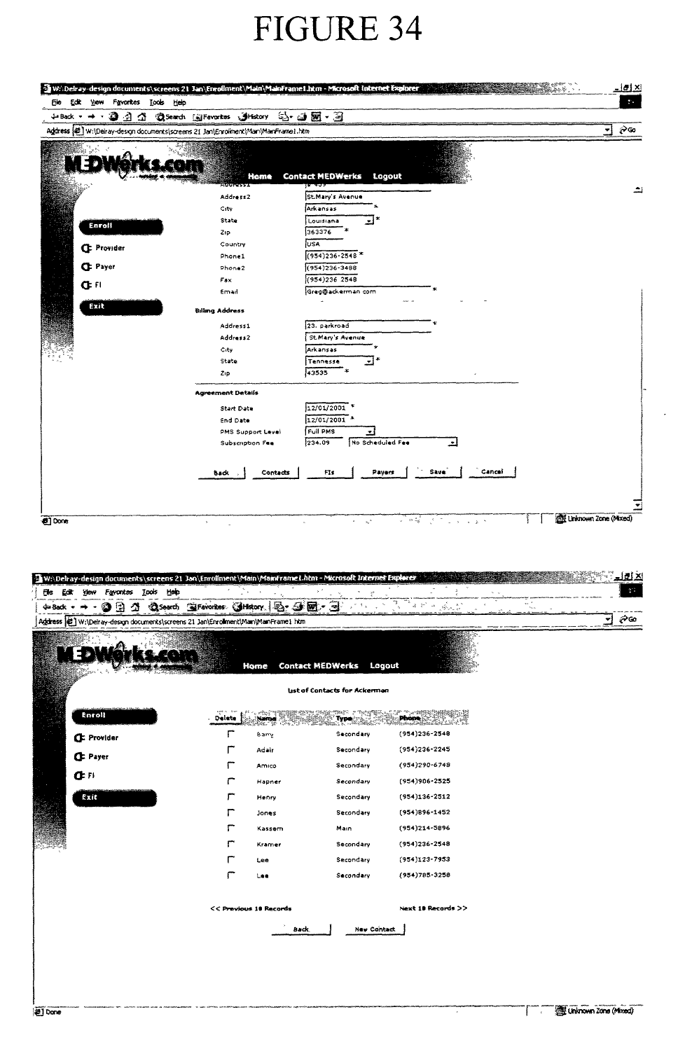

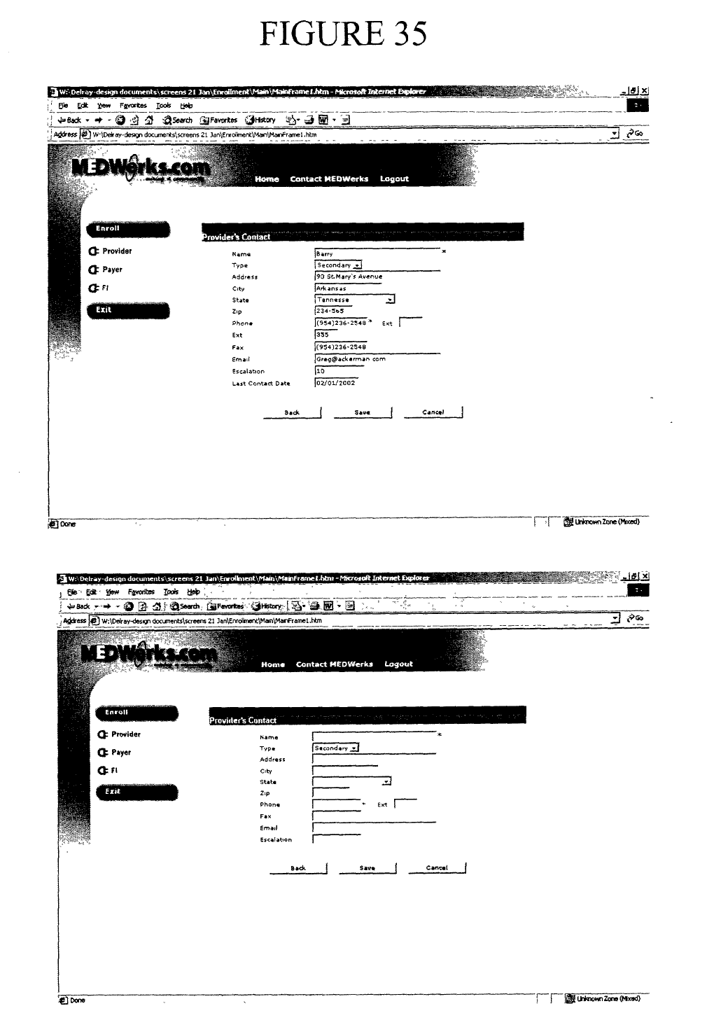

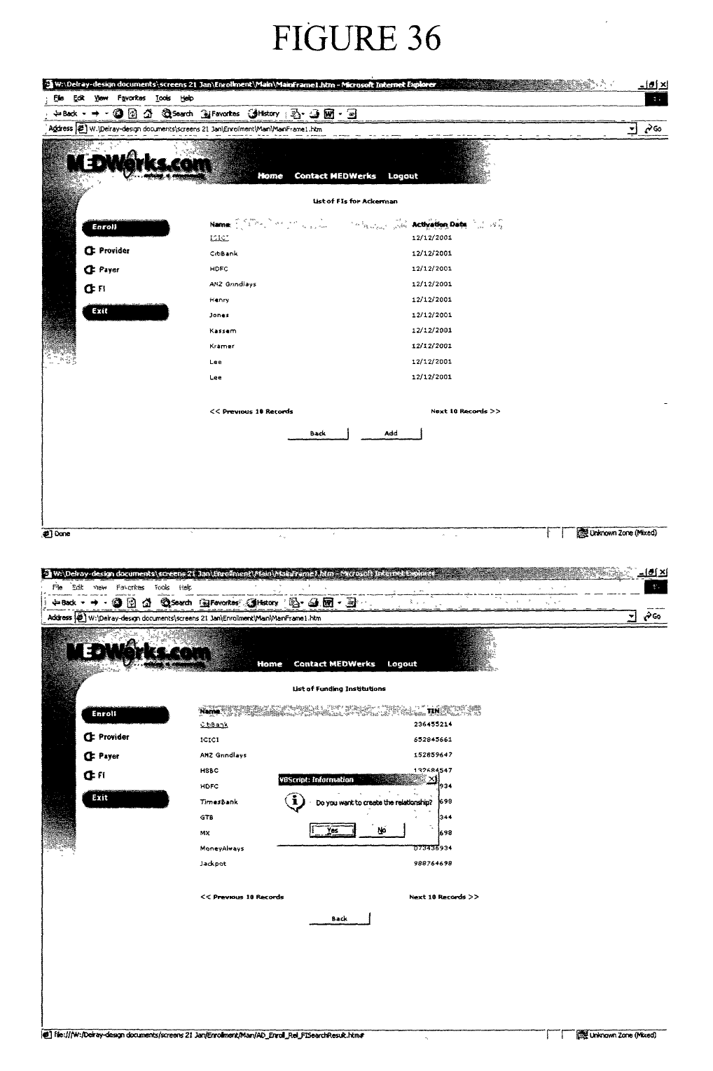

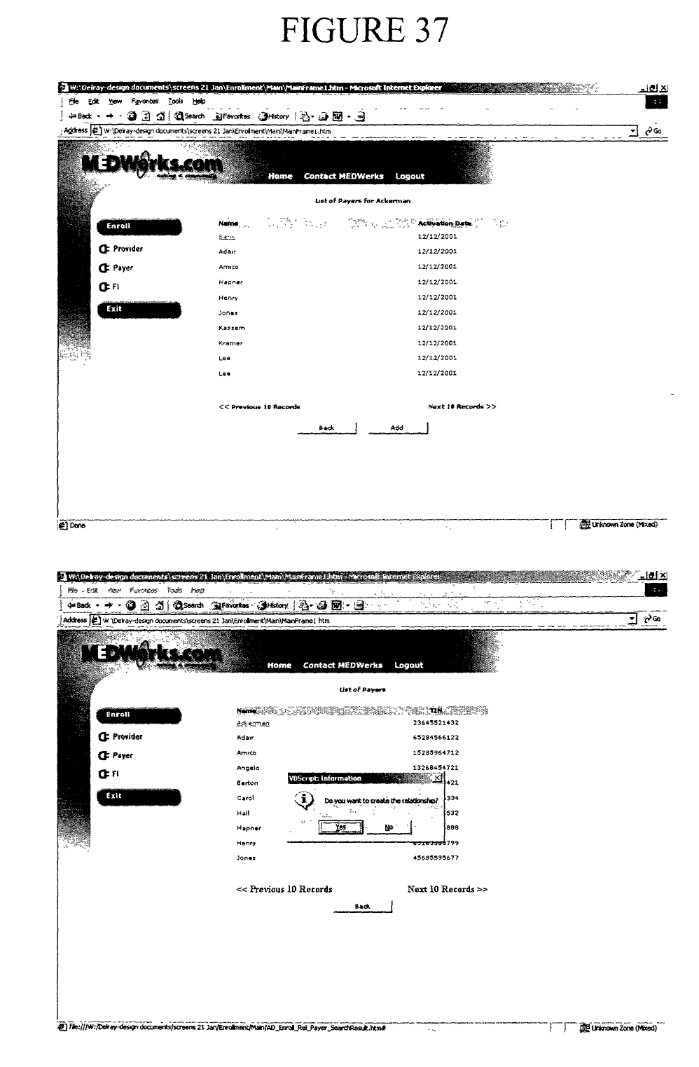

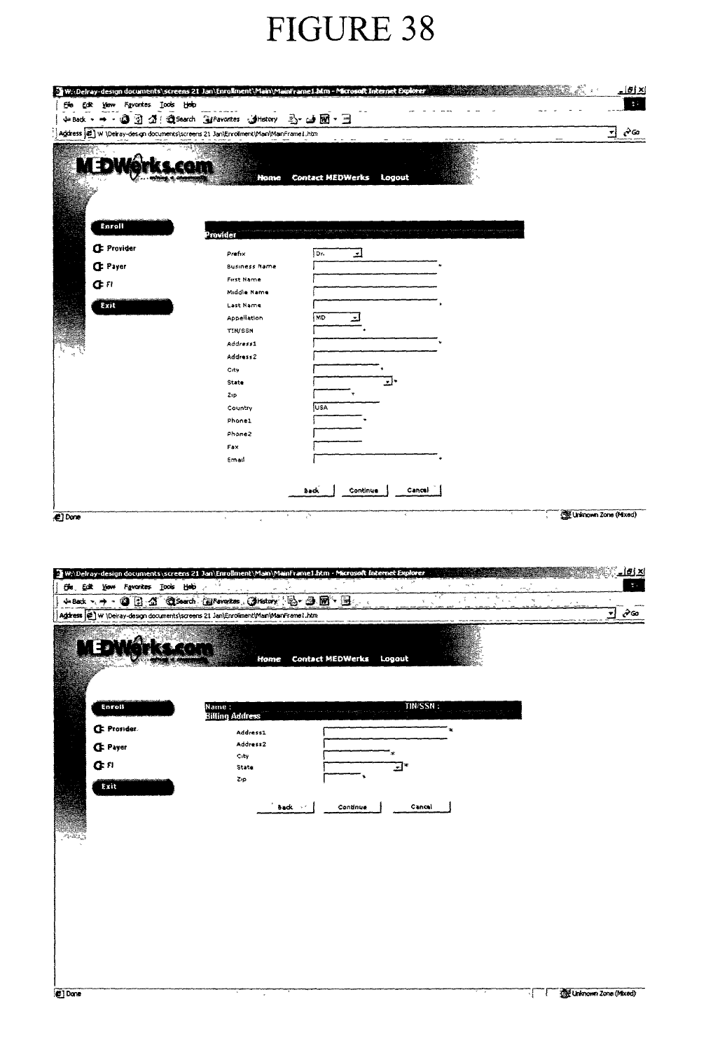

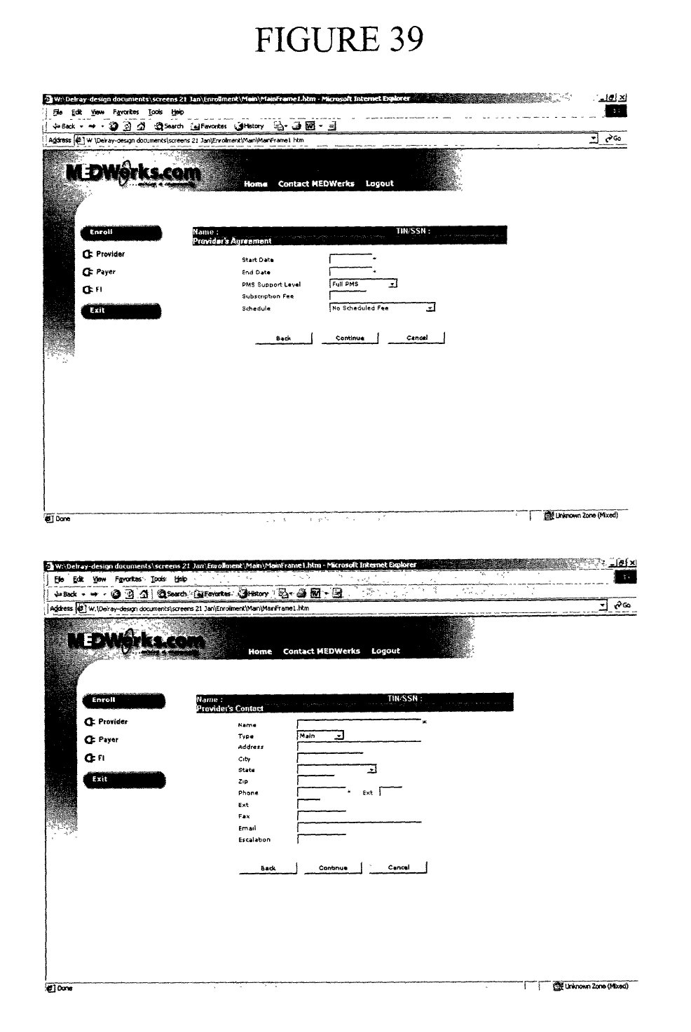

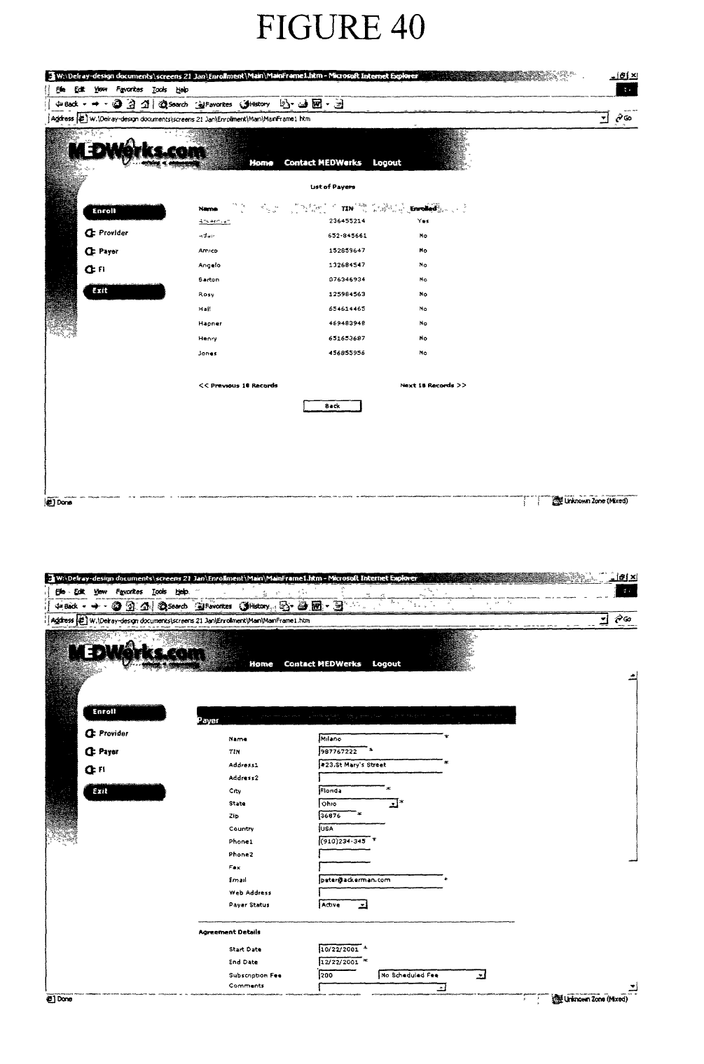

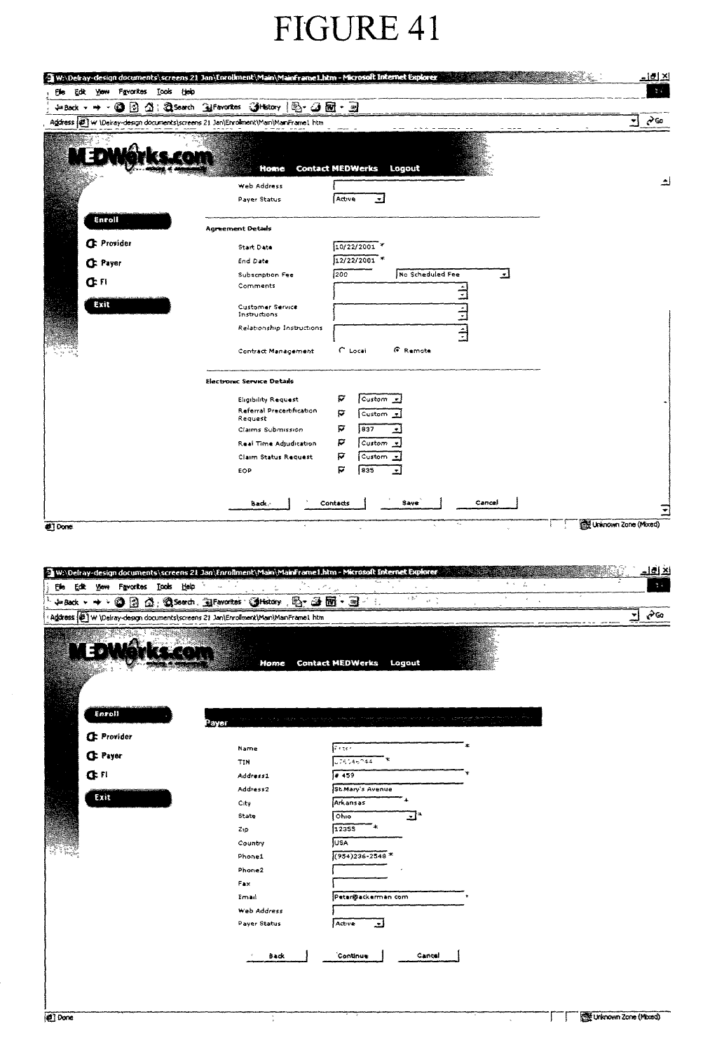

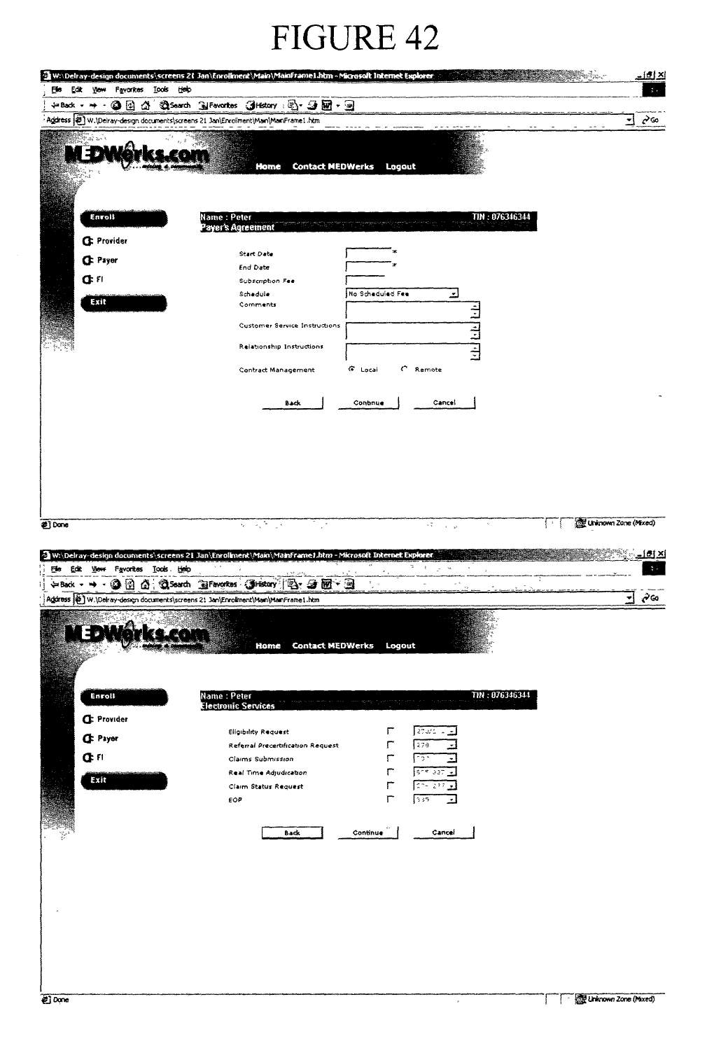

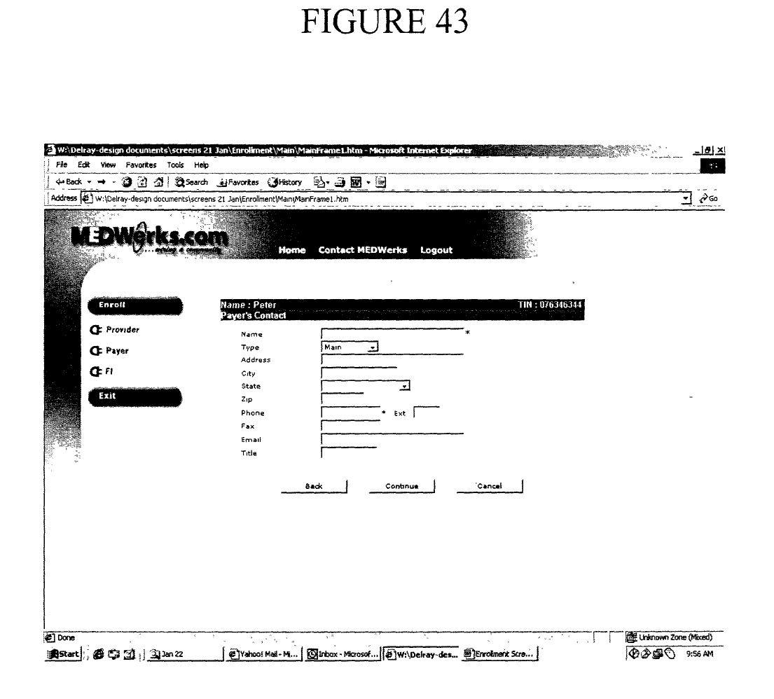

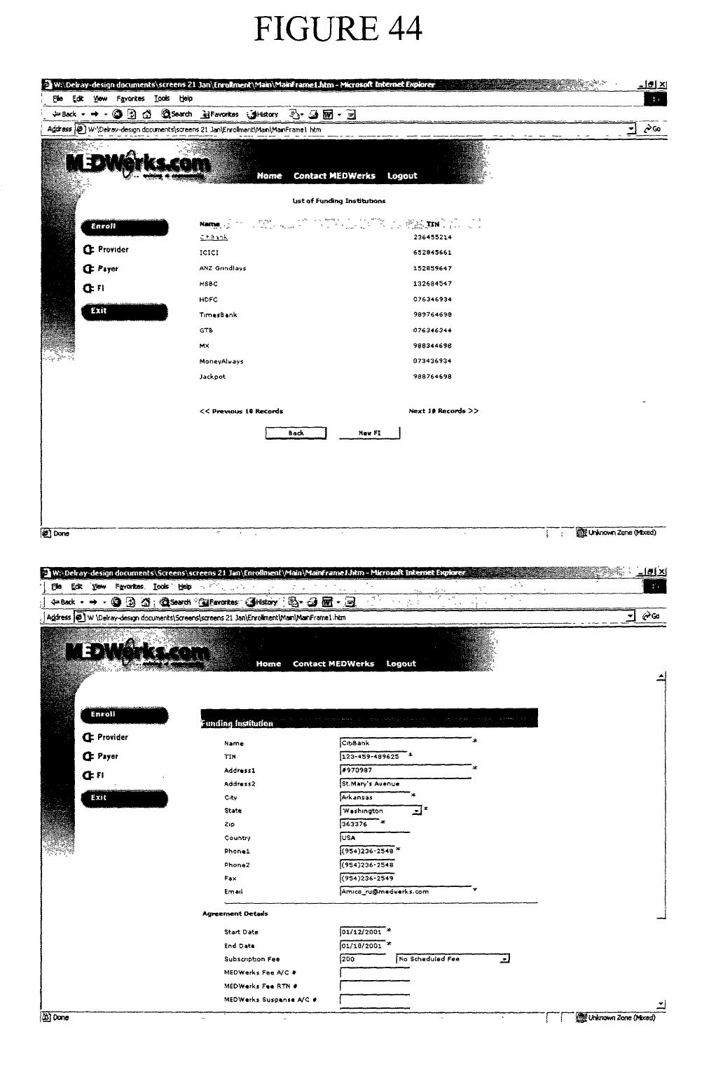

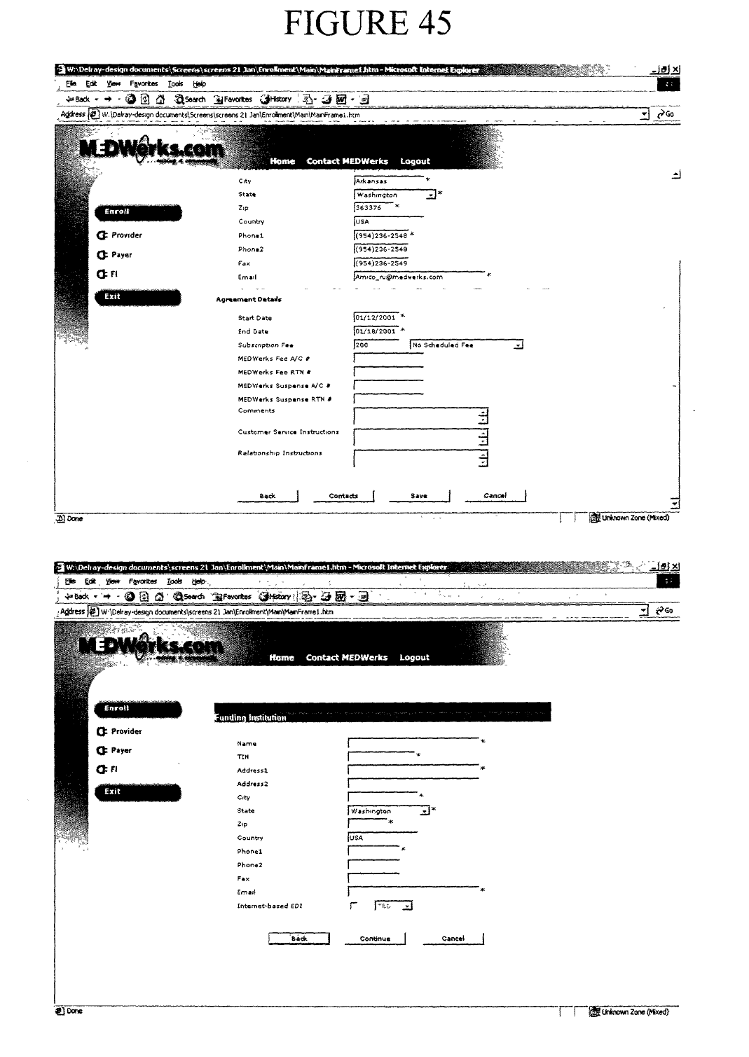

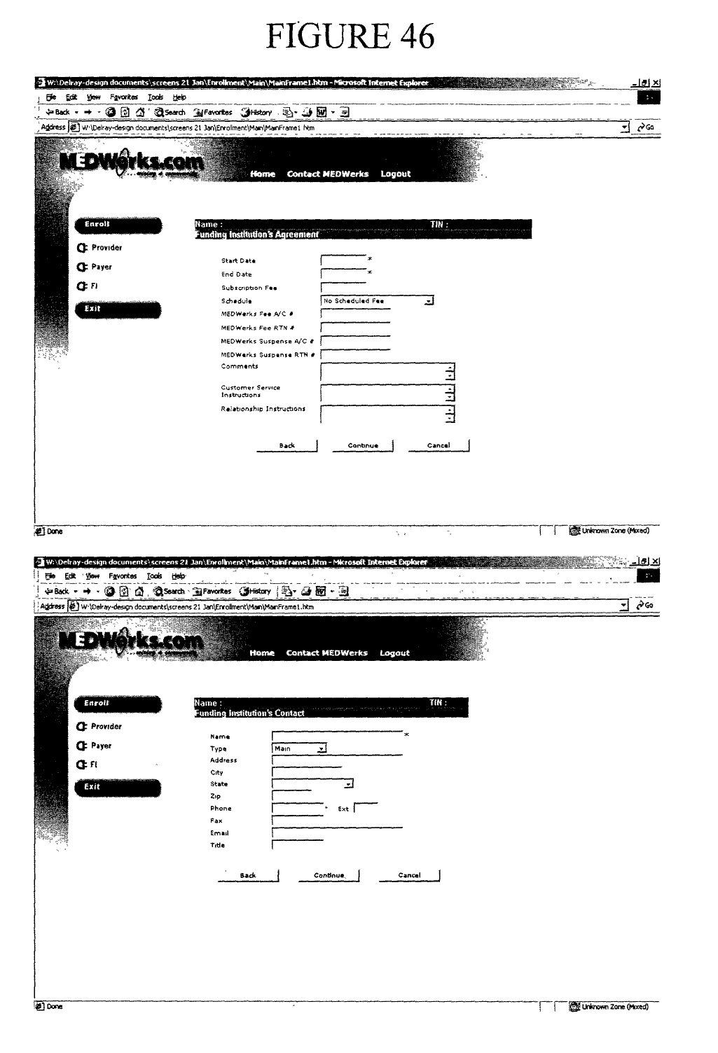

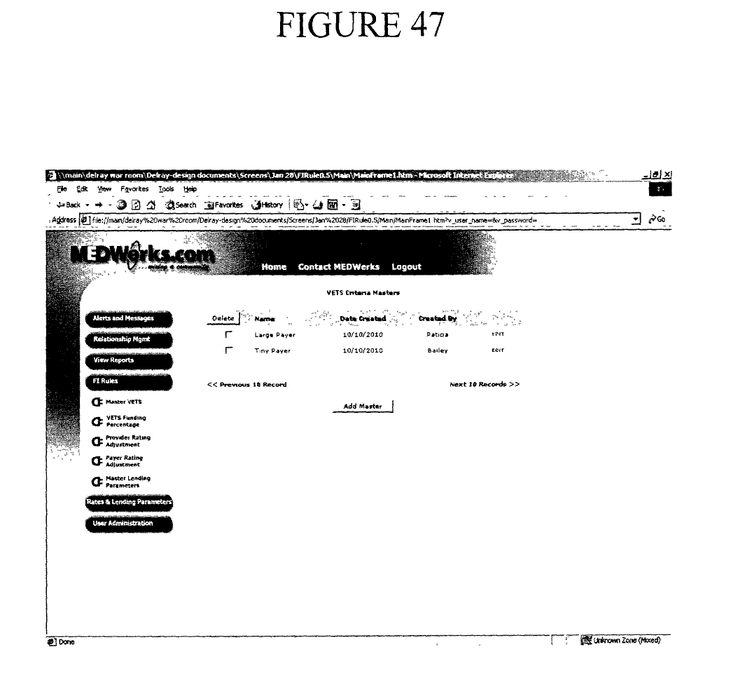

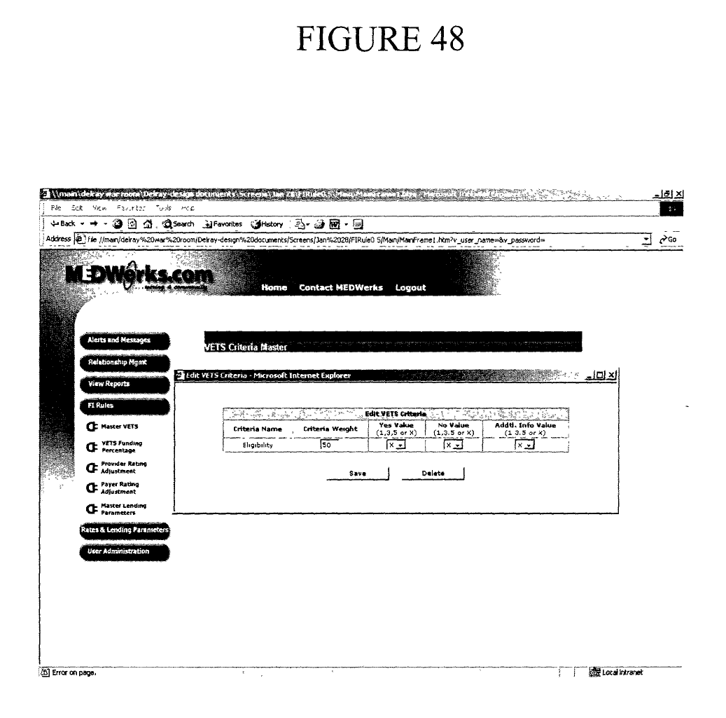

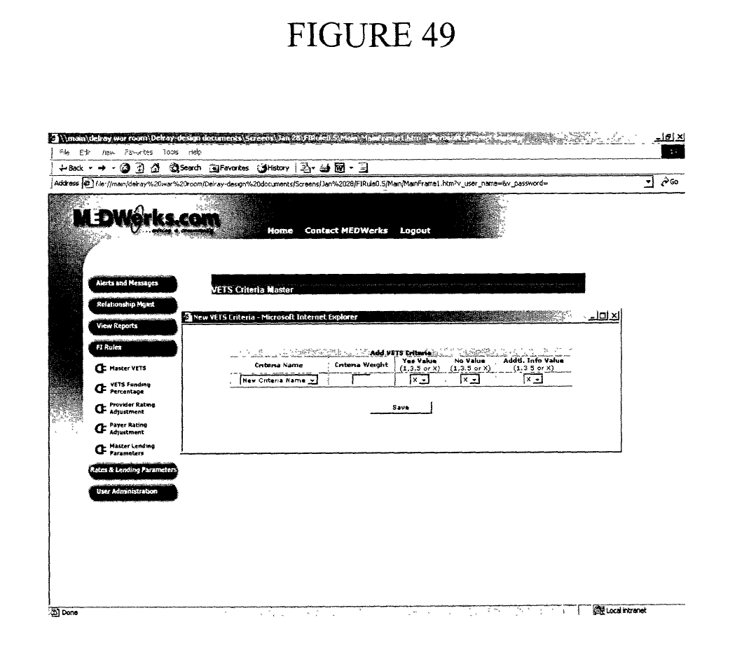

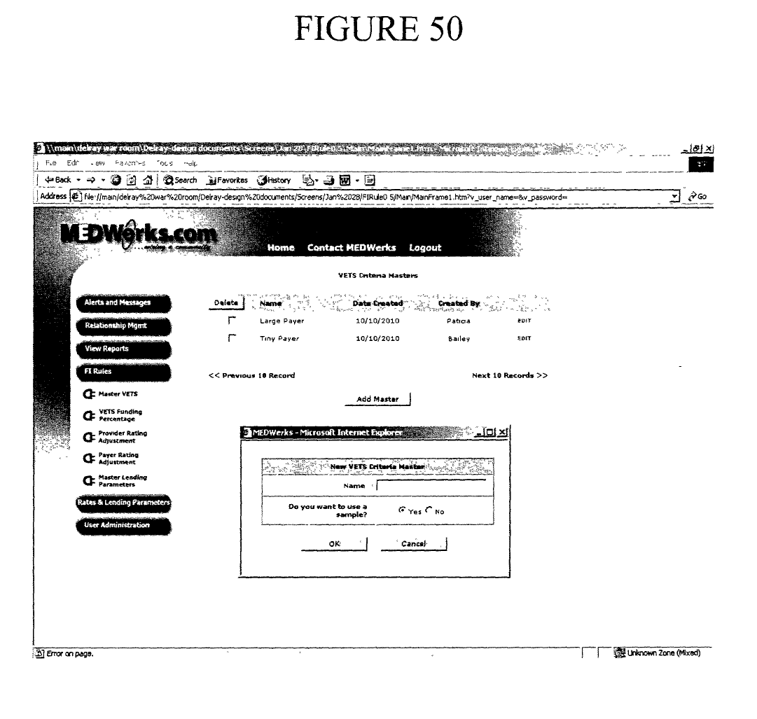

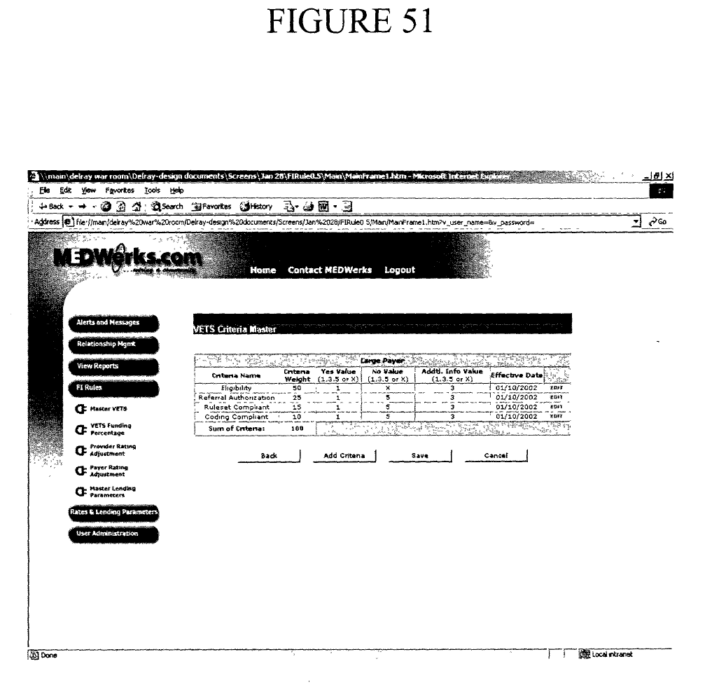

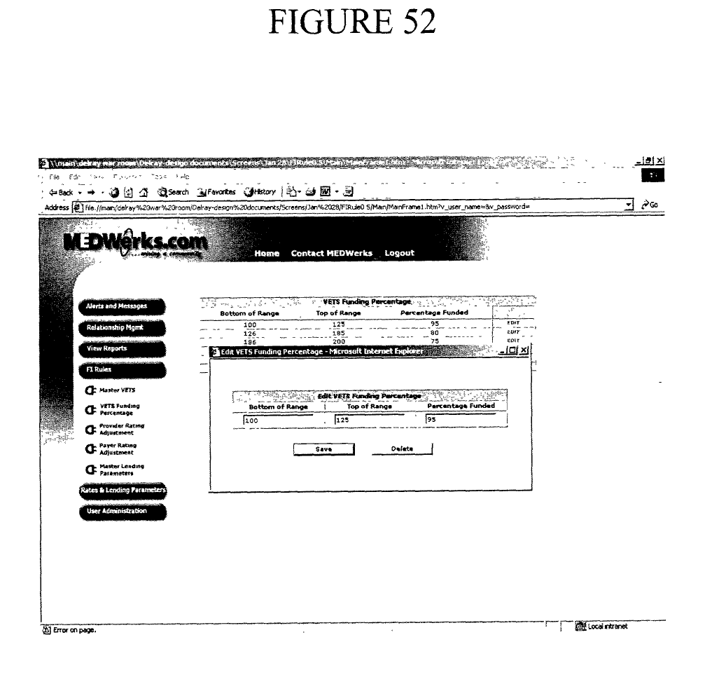

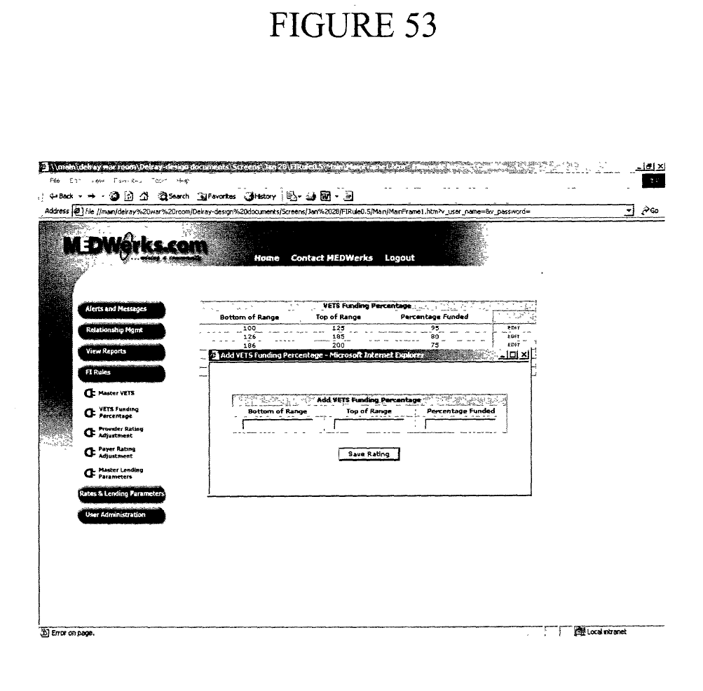

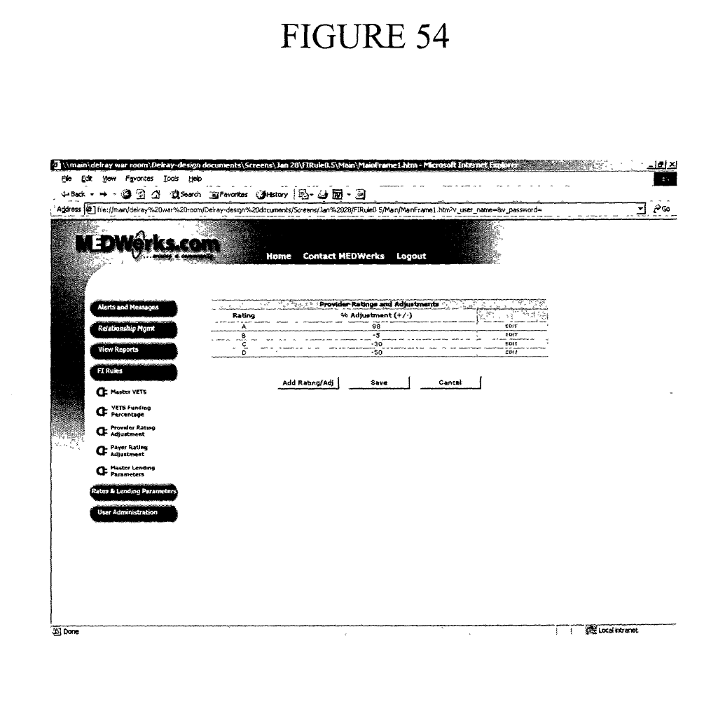

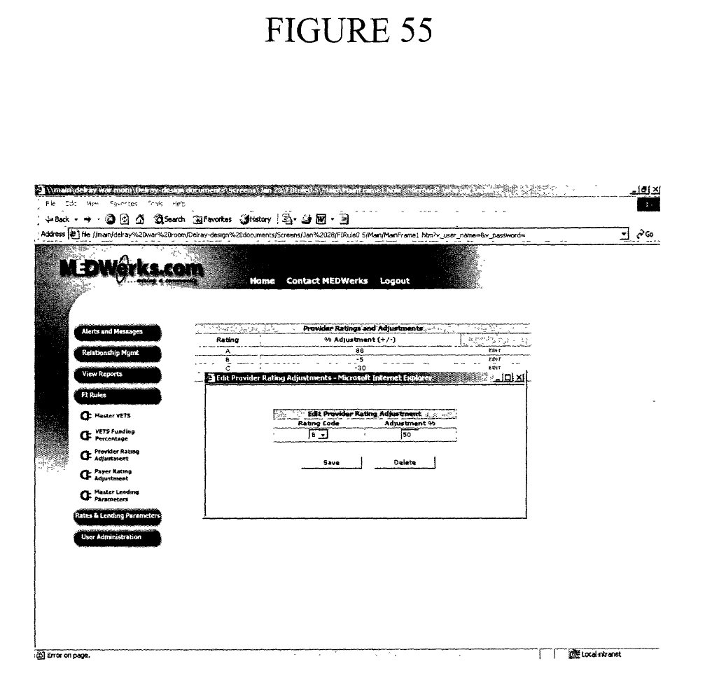

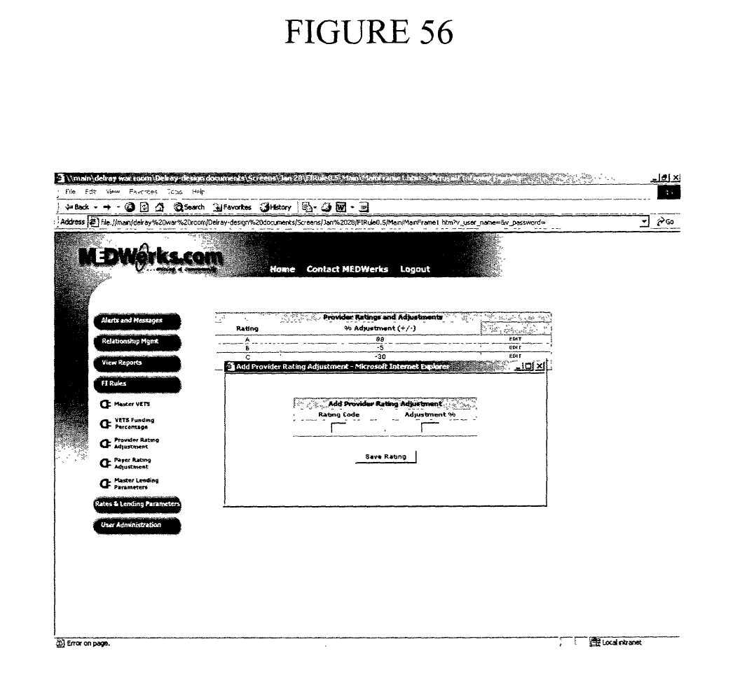

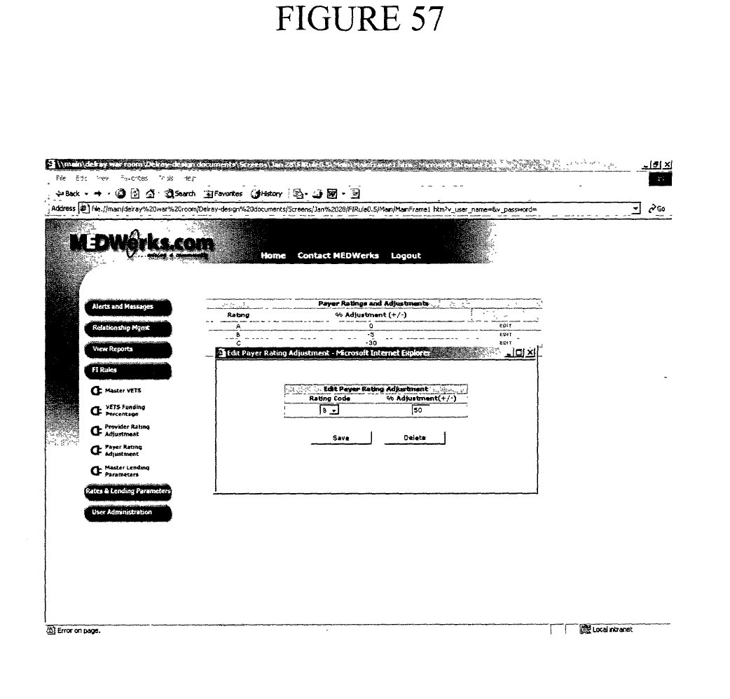

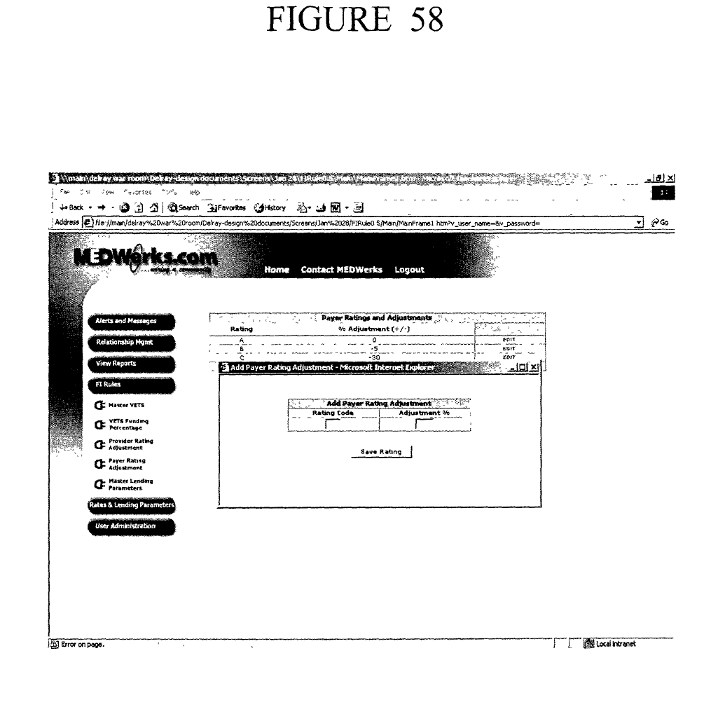

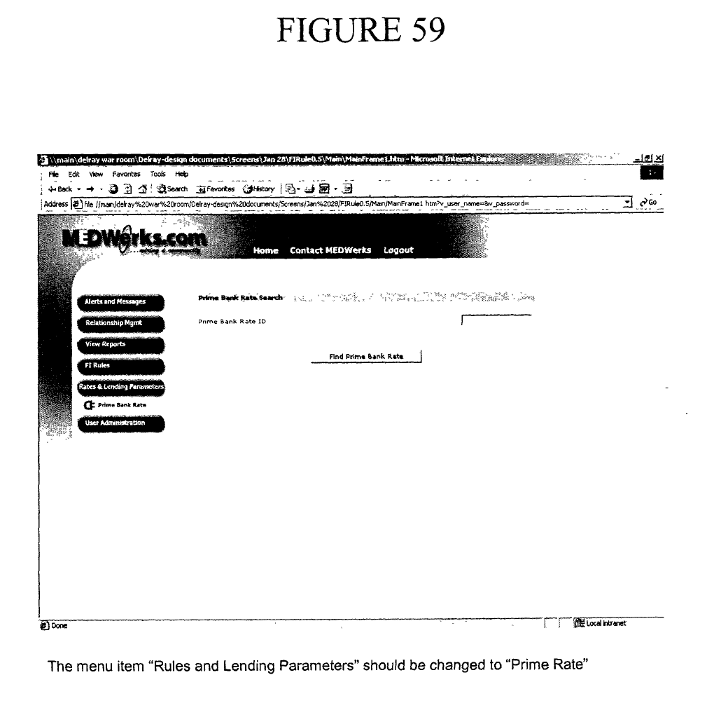

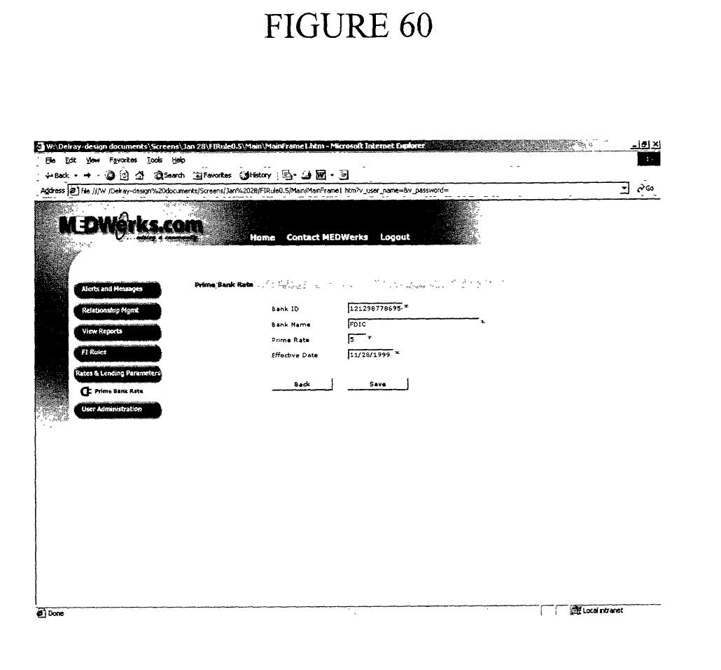

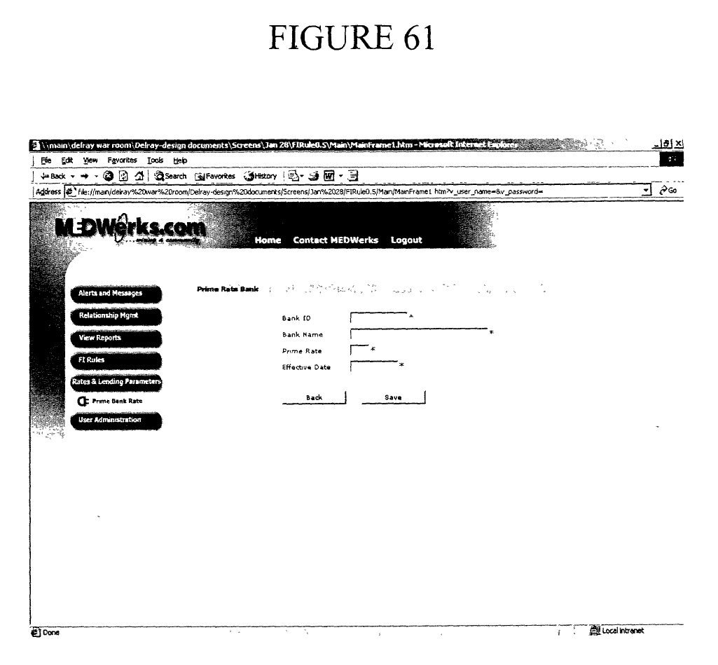

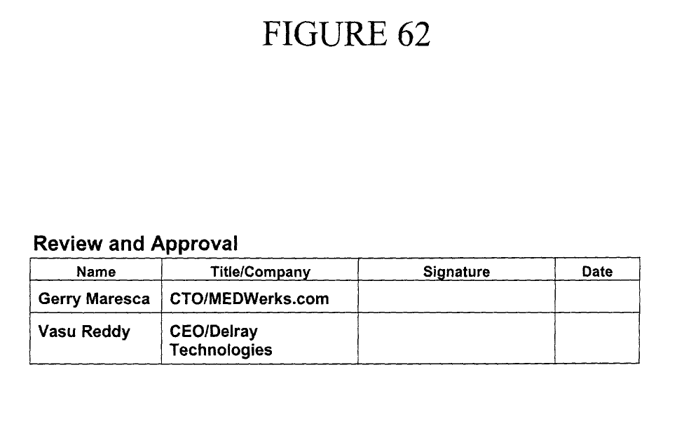

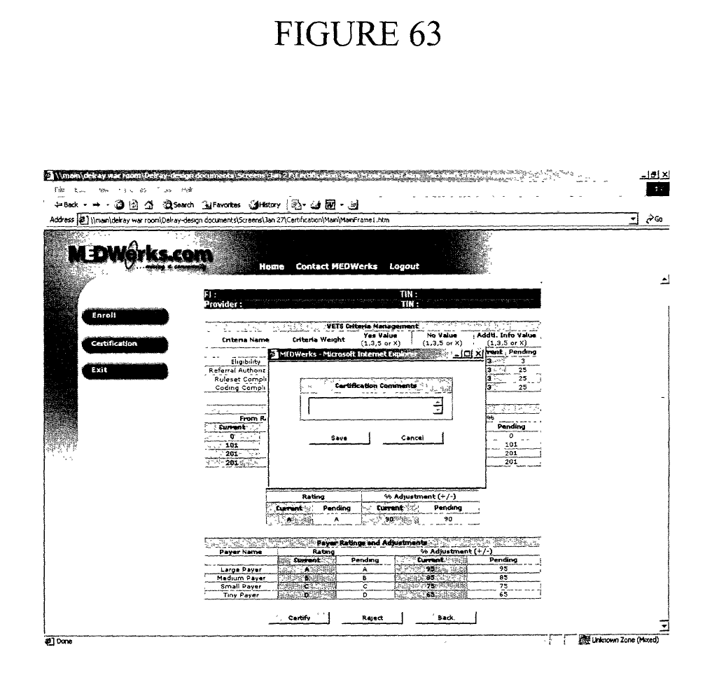

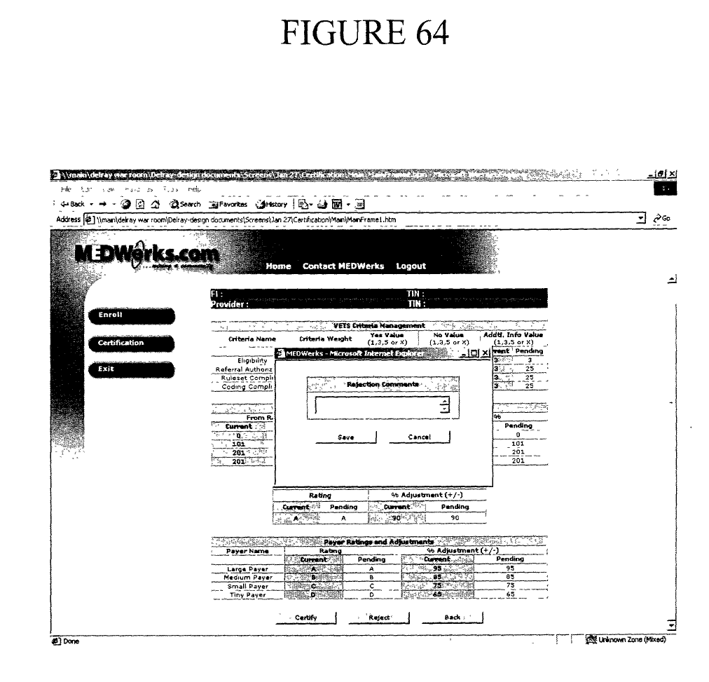

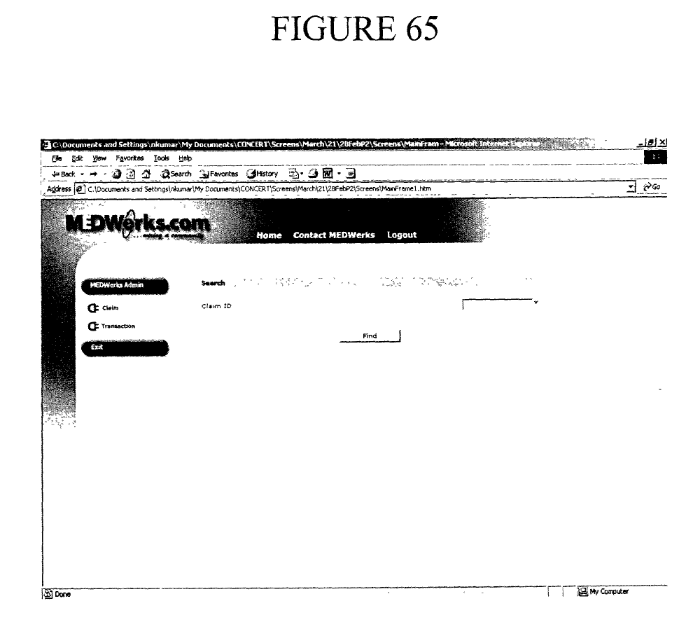

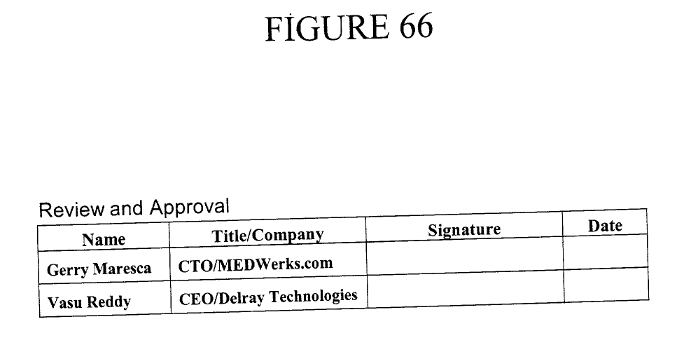

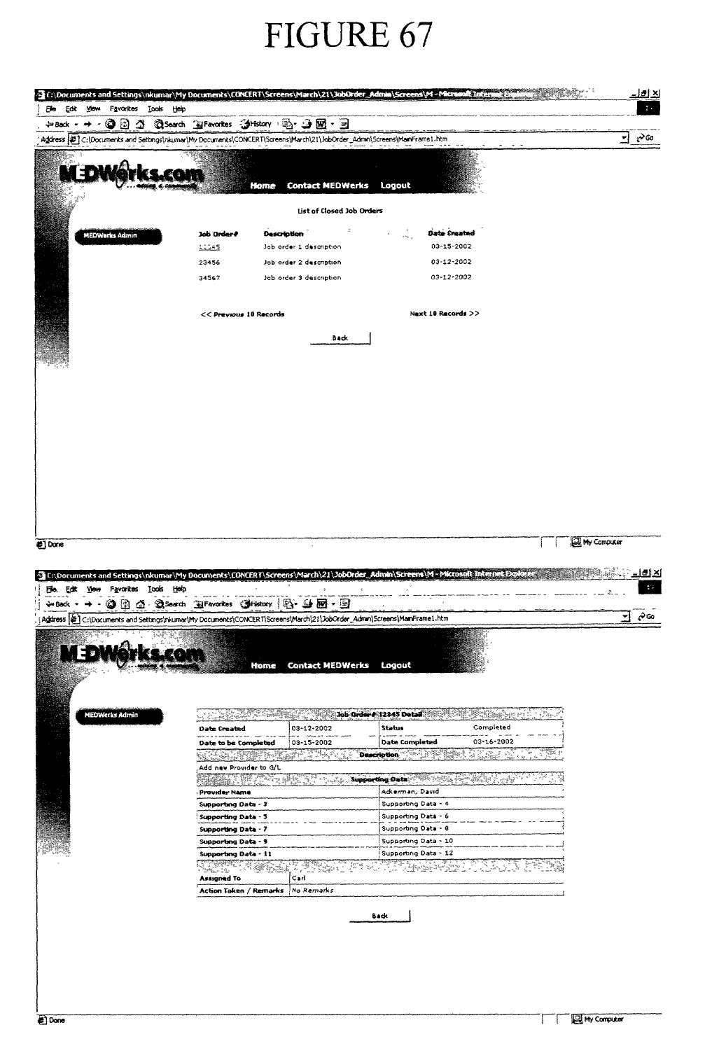

Example Graphical User Interface Screens FIGS. 5-30 present examples of GUI screens, in accordance with embodiments of the present invention.

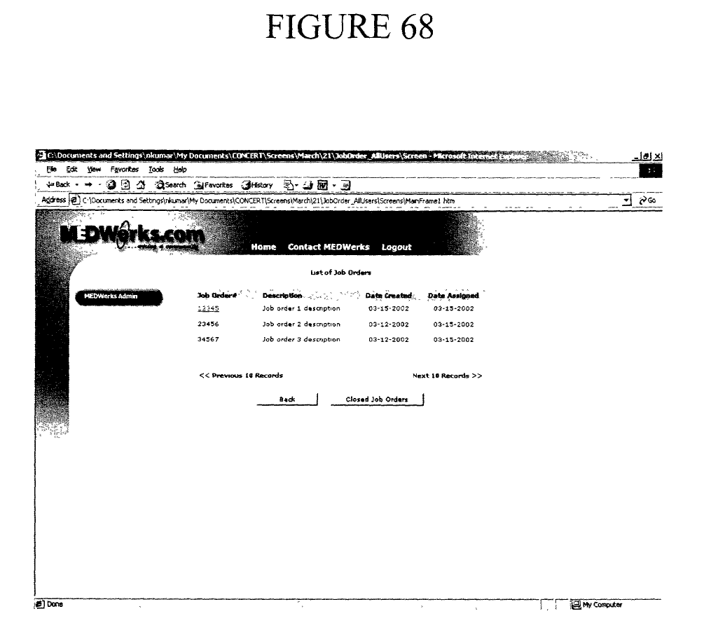

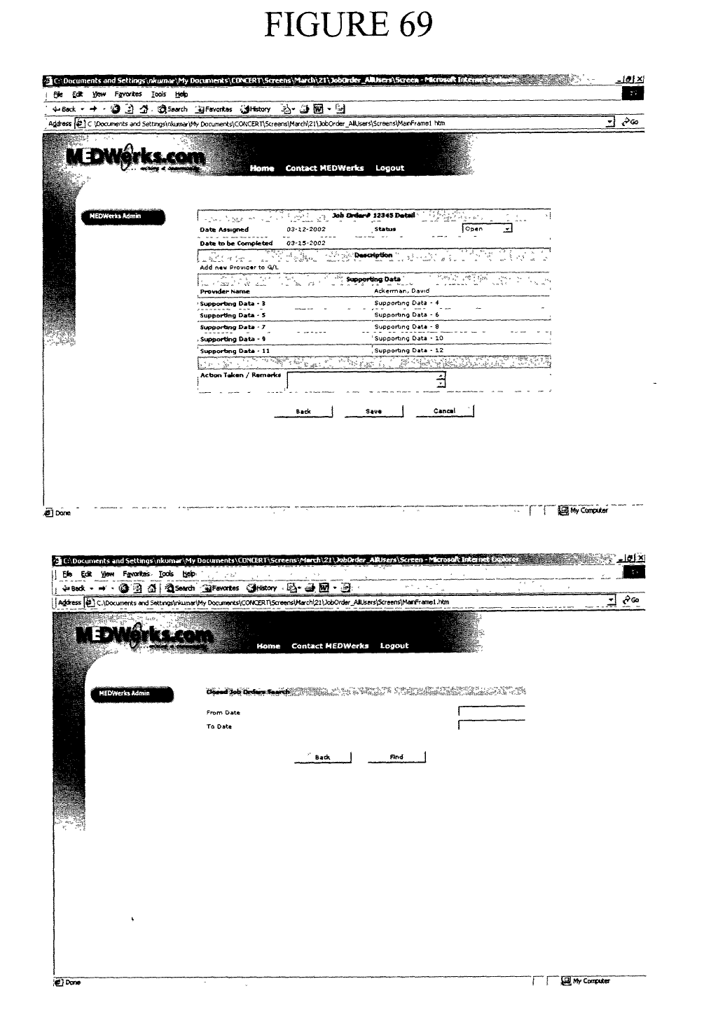

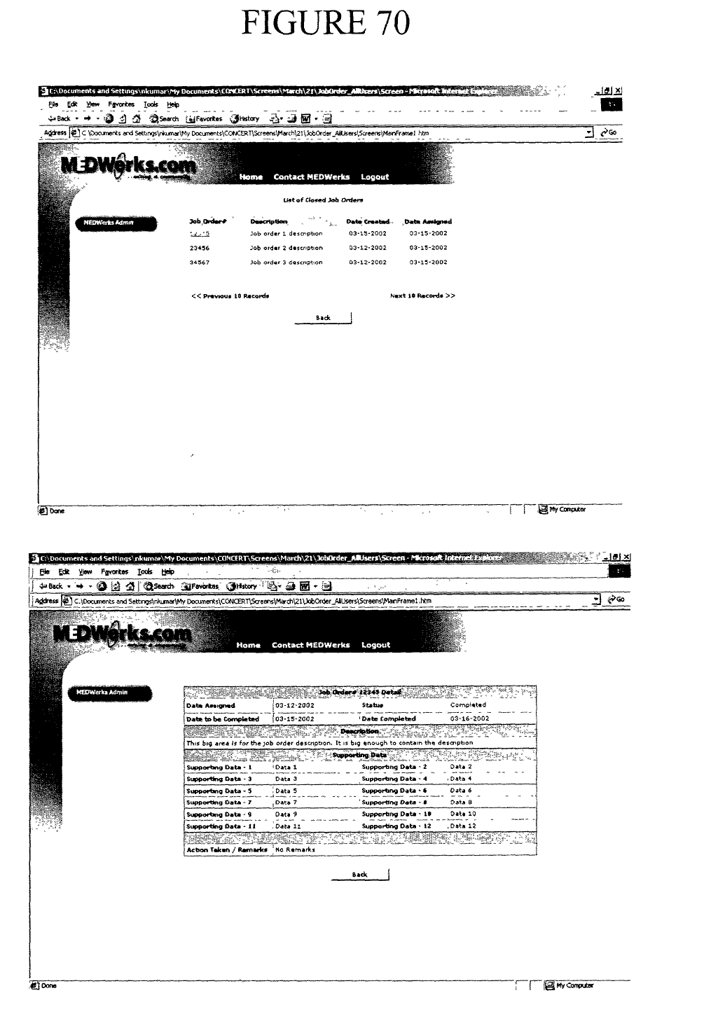

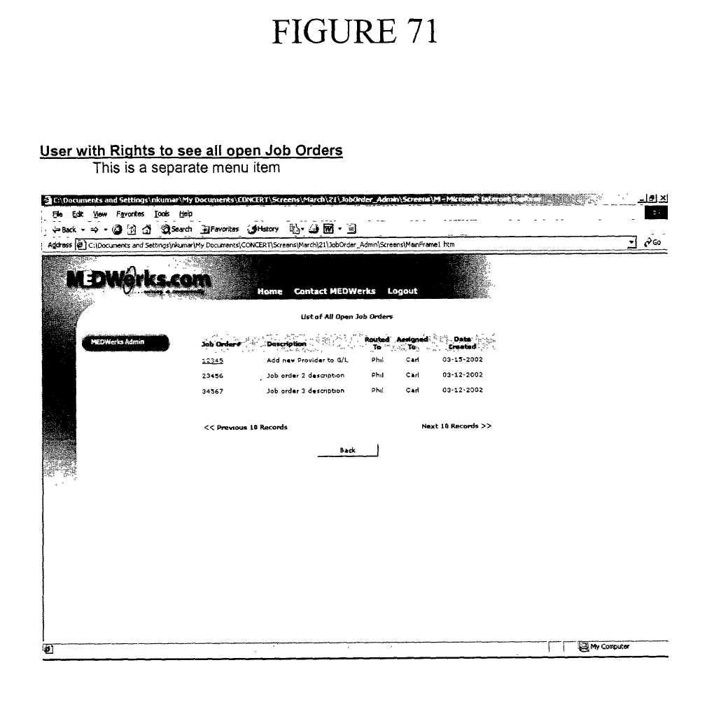

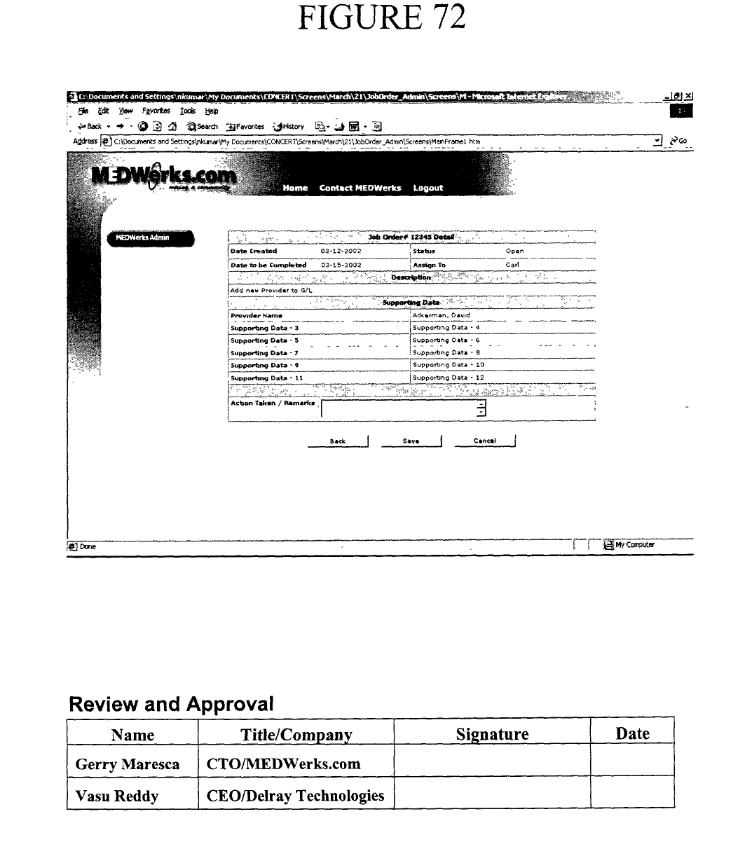

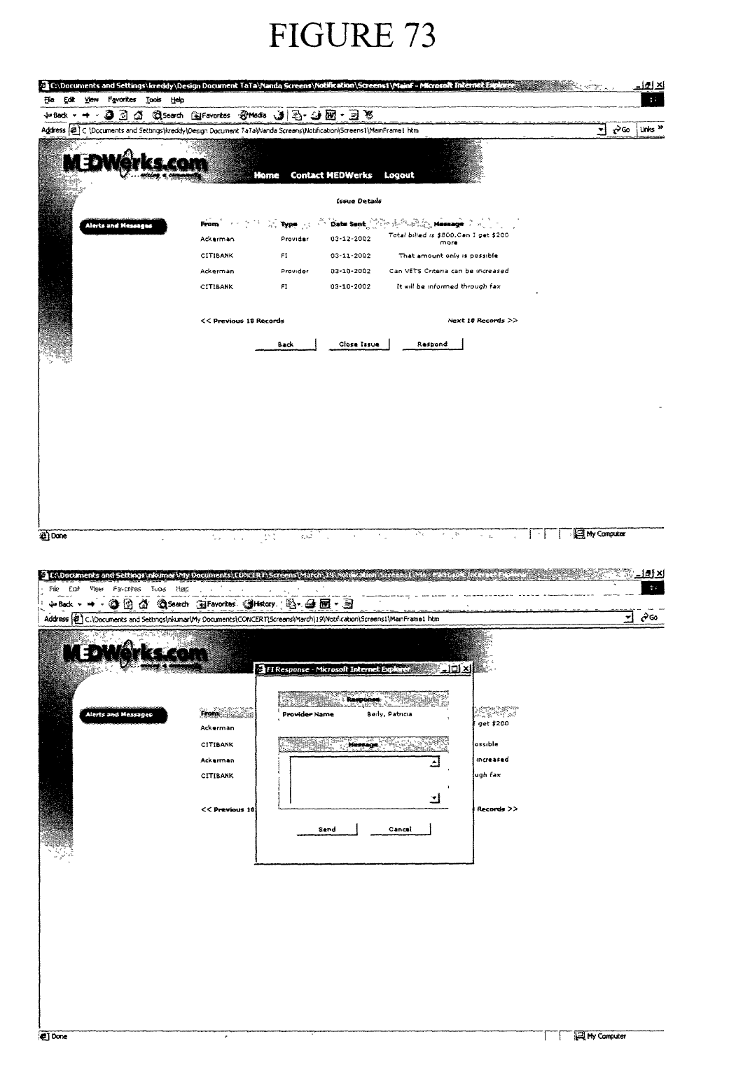

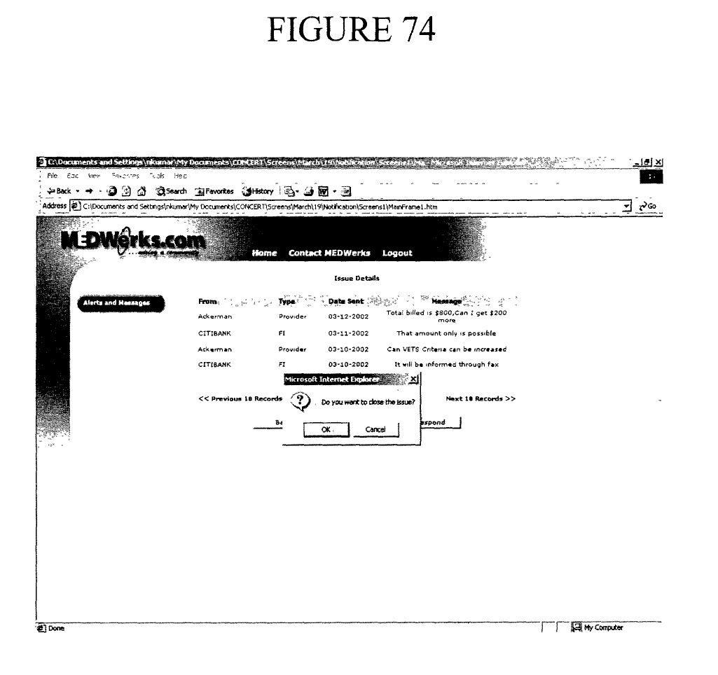

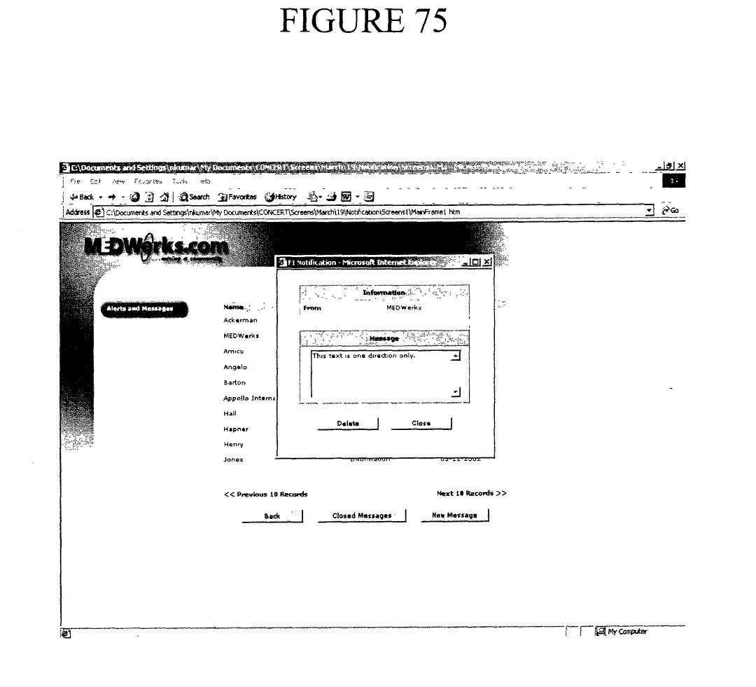

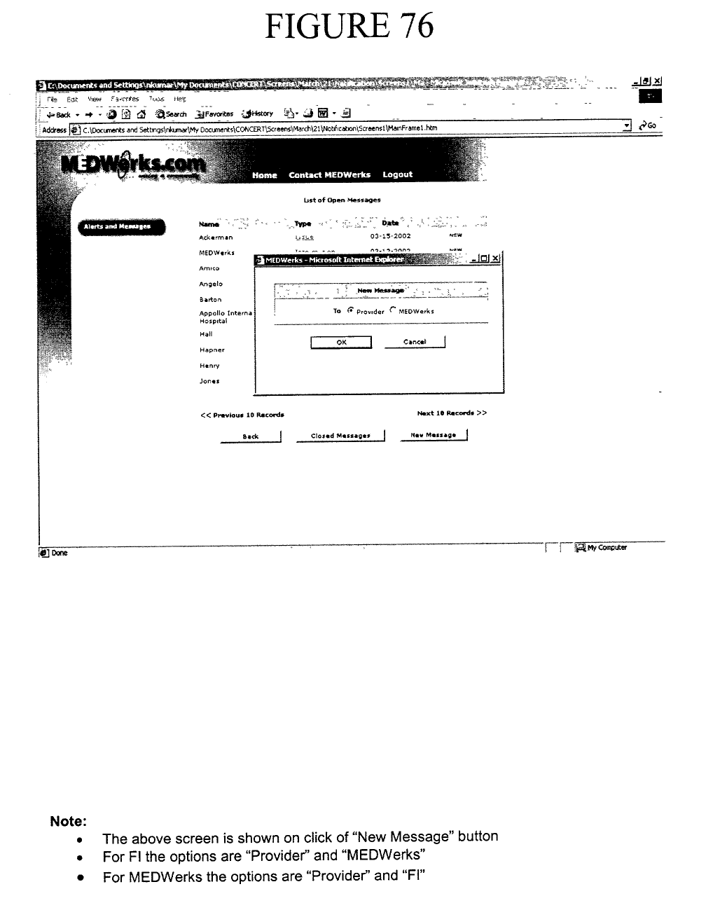

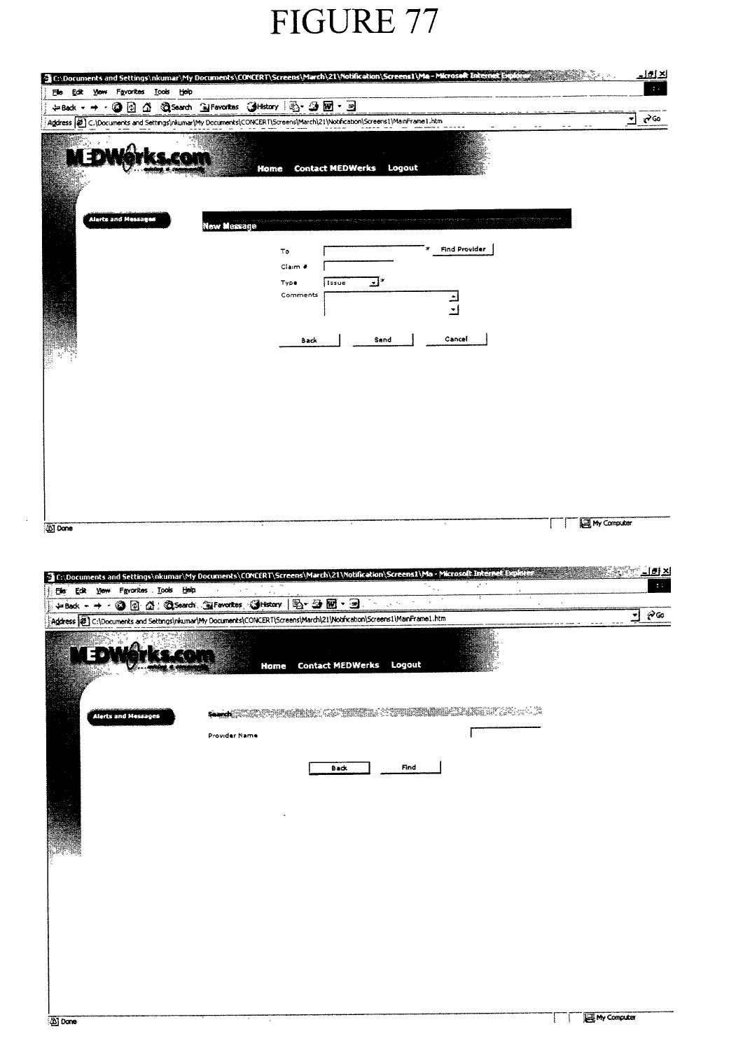

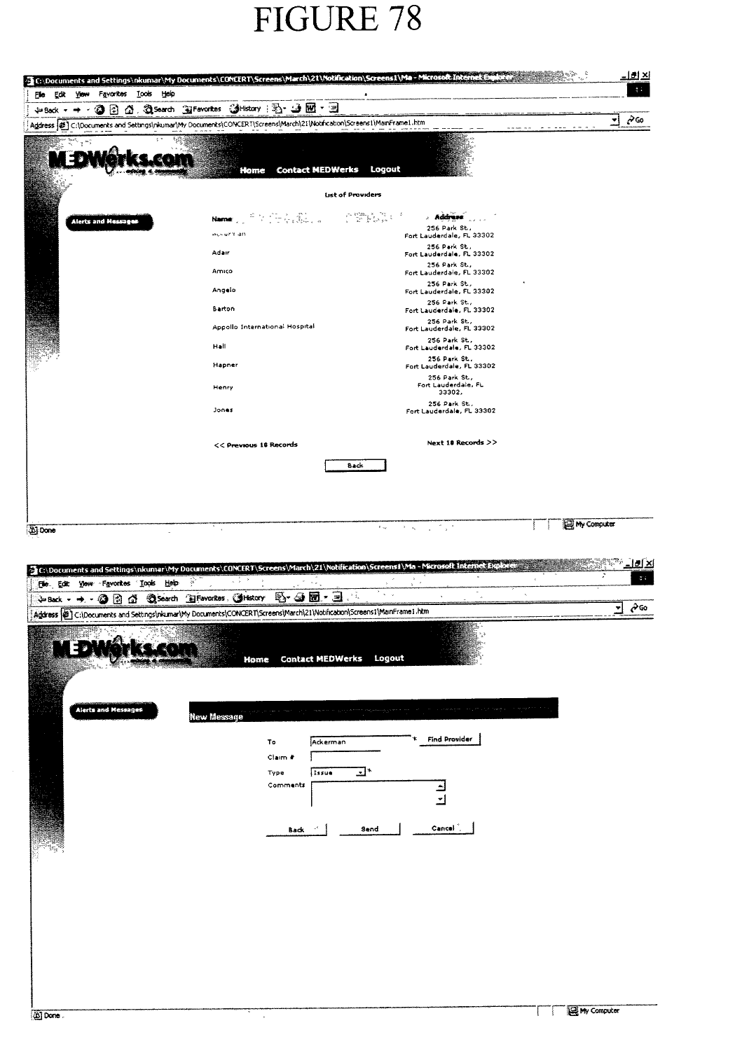

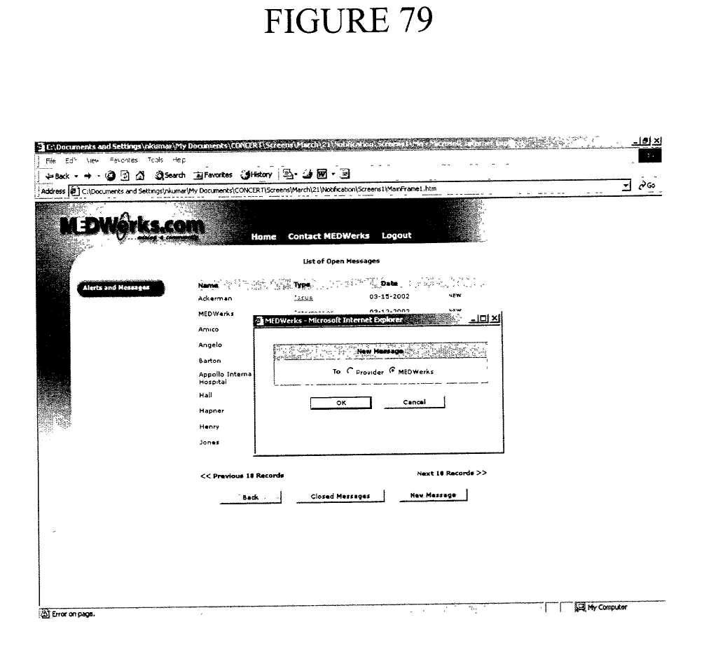

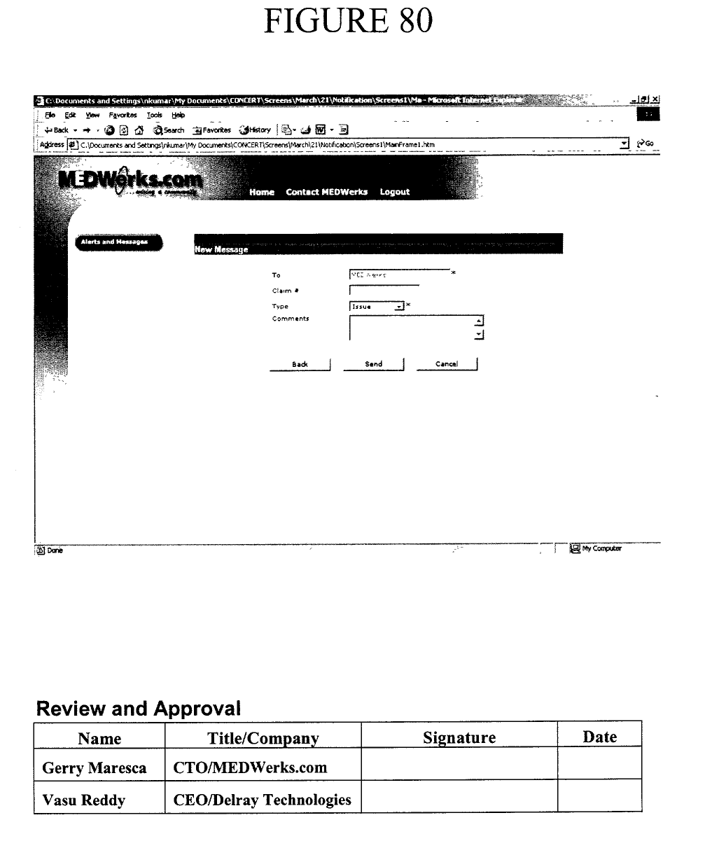

FIG. 5 is an exemplary screen shot of Provider Information. FIG. 6 is an exemplary screen shot of Payer Information. FIG. 7 is an exemplary screen shot of Funding Entity Information. FIG. 8 is an exemplary screen shot of Funding Entity Data Entries. FIGS. 9-18 are exemplary screen shot of the VETS. FIGS. 19-22 are exemplary screen shots of the Claim details. FIGS. 23-28 are exemplary screen shots of processes which use real-time decision-making. FIGS. 29-80 are additional exemplary screen shots of the present invention.

Claim Checking Detail

The Pre-Claim and Claim Checking Processes of steps 211 and 230 of FIG. 2, steps 305 and 320 of FIG. 3, and step 415 of FIG. 4 are further detailed below.

The Claim checking process of an embodiment of the present invention comprises comparing the Claim to VETS information. In one embodiment, VETS is created by a continuous Validation of Data against pre-established Rulesets. VETS comprises VETS Criteria Management, VETS Funding Percentage, VETS Provider Rating and Adjustment, and VETS Payer Rating and Adjustment. The Validation of Data and the Rulesets in accordance with embodiment of the present invention are explained below.

Validation of Data

The Validation of Data comprises validating data against the Subscriber/Group, the Payer, the Provider, and the Funding Entity parameters.

Data Validation. Data Validation includes verified, real-time confirmation that all fields of the data are accurate and that the information required for processing is available. The Data Validation also ensures the uniformity of data present from multiple data entry points. In addition, the VETS monitoring system provides a mechanism for showing deviation analysis for prior claims. Thus, every time a transaction is processed, CONCERT 120 gains knowledge. Each field on the Claim is validated for data type, data content, and data relationships.

Data Type Validation. Data Type Validation ensures that fields expected to be numeric are numeric, that dates are dates, and that alphanumeric fields do not contain unacceptable elements.

Data Content Validation. Data Content Validation ensures that fields contain reasonable information.

Data Relationship Validation. Data Relationship Validation ensures that the relationships between fields that have defined relationships are valid.

File Validation. File Validation provides verified, real-time indication that the file information present on the Claim is valid when compared against information available on the system files. File Validation comprises Diagnosis Validation, Procedure Validation, and Provider Number Validation.

Diagnosis Validation. Each diagnosis on the Claim is validated against the diagnosis file. The ICD-9 coding scheme is the accepted standard, however there can be variations on justifying and filling, as well as on Payer-specific codes to trigger system functions. Diagnosis Validation is Payer-specific due to potential variability among Payers 155. After the Diagnosis Validation, relationship editing to other Claim information is performed.

Procedure Validation. Each procedure code on the Claim is validated against the procedure file. Various procedure coding schemes are used (e.g., CPT-4, HCPCS, HCPS, and UB92 are all current procedure coding schemes; all three are used for medical offices for such things as fee schedules an interactions with Participants, such as Medicare). There is a greater degree of Payer-specific rules for procedure codes than diagnosis codes. Due to this variability among Payers 155, the Procedure Validation is Payer-specific. After the Procedure Validation, relationship editing to other Claim information is performed.

Provider Number Validation. The Provider number presented on the Claim is verified against the Provider file. With the present invention, multiple Payers 155 can have different coding schemes to represent a single Provider 130. This process validates that the Provider number is valid for the specific Payer 155 of the Claim. Following the Provider Validation, relationship editing to other Claim information is performed.

Bundling Edits. The Validation Process identifies services that were incorrectly coded by the Provider 130. These are put into bundling edits. The bundling edit identifies, for example, pairs of CPT-4/HCPCS codes that cannot coexist on a Claim in a CPT-4/HCPCS based reimbursement system. This component also identifies codes that should not pay in conjunction with other codes on the same Claim, or codes on other Claims for the same member on the same date of service.

The Claim is prepared for bundling evaluation by creating code pairs and determining a Payer Ruleset. The Payer Ruleset tests regulations and testing against historical trends for real-time pre-adjudication of Claims to reduce costs, increase accuracy, lower risk, and increase the probability of payment. The Payer Ruleset is described in further detail below.

In an embodiment of the present invention, the Claim history for the Claim under evaluation is selected according to the Payer Ruleset. The Payer Ruleset specifies the type of bundling package that is used for the particular Payer 155. The Claim is evaluated and any repackaging then occurs. If the Claim contains global bundling edits that require exception processing, the Claim is forwarded to the end of processing module. If the Claim does not require exception processing, it is forwarded to global pricing module. In an embodiment of the present invention, the most common types of bundling edit categories include the following:

Fragmented Procedures. Fragmented procedures occur, for example, when a Provider 130 submits a Claim with two or more CPT codes that are components of a comprehensive CPT code. The combined price of the two procedures is greater than the single comprehensive code that assumes the two codes billed.

Mutually Exclusive Procedures. Mutually Exclusive Procedures are procedures that could not be reasonably performed by the same Provider 130 on the same Patient 165. The Claim is edited to suspend for further review or to deny payment of one of the codes.

Most Extensive Procedures. Most Extensive Procedures are procedures that identify Claims with two or more similar procedures, but with different levels of complexity.

Rulesets

The following is a description of each Ruleset for an embodiment of the present invention, as well as examples of where each Ruleset is used during the process as a whole. In an embodiment of the present invention, Rulesets can be modified on an interactive, real-time basis.

Subscriber and Group Ruleset. The Subscriber Ruleset is determined by the subscriber number on the Claim and contains Employer group and benefit rule parameters. The Group Ruleset is determined using the Subscriber Ruleset or Claims information and contains any Group-specific processing parameters. The Group Ruleset is used to determine if a referral is required, to confirm authorization for a procedure, and to ensure against duplicate services on the current Claim, or from previously processed Claims.

Payer Ruleset. The Payer Rulesets check compliance with regulations and testing against historical trends for real-time pre-adjudication of Claims to reduce costs, increase accuracy, lower risk and increase the probability of payment. The Payer Ruleset is determined using the Group Ruleset and Claim information, such as the Payer name and ID. The Payer Ruleset parameters are used throughout the system to emulate each Payer's specific processing rules where flexibility is required.

During Claims submission, Payer-specific processing Rulesets, such as Global Services, Multiple Surgeries, and Bundling are applied to the Claim. After bundling, the Payer's payment rules are applied in order to price the Claim. The Payer Ruleset is also used to determine, for example, if services or age qualify for government programs in the coordination of the benefit process. Like the Group Ruleset, the Payer Ruleset is also used to determine referrals, authorization, and duplication of services.

Provider Ruleset. The Provider Ruleset is determined using Provider information and contains parameters needed to correctly price the services rendered for the responsible Payer 155. The Provider Ruleset contains information relating to the Provider 130, the Payer 155, pricing type, and pricing table.

The Provider Ruleset is accessed during the Payer payment rules process.

The Payer's database is accessed to determine the Provider Ruleset and ensure the correct pricing. The Provider Rulesets is used to determine correct packaging and routing of a Claim.

Funding Entity Ruleset. The Funding Entity Ruleset is determined by the Provider 130, the Payer 155, or the Funding Entity 160 and contains parameters to assist in various areas of the financial aspect of the Claims process.

Ruleset Benefits. The Ruleset benefits include the following: 1) With business-to-business (B2B) interaction, the present invention establishes non-reputable identification of Participants involved in the transaction; 2) For compliance with the Fraud Claims Act, the invention verifies Providers'coding structures to ensure compliance of each individual Claim; 3) The present invention verifies physician's credentials on a on a quarterly basis to determines if license is current; 4) The present invention ensures eligibility for the Provider 130, Patient 165, plan, and referred physician to minimize Incurred But Not Recorded (IBNR) transactions; 5) The invention provides for collaborative, interactive editing of Claims using such features as artificial intelligence and fuzzy logic to define a range of non-compliance that the Provider 130 would still accept to isolate the transactions that require interaction, which reduces negotiation and transaction time; 6) The present invention creates a suggested rating system (Risk Asset Return on Capital adjustment formula), which is made available to the Funding Entities 160; 7) For asset backed lending and borrowing based certified lending programs, Funding Entities 160 can verify out of trust assets and the Provider's collateral position; and 8) The present invention provides time-stamped, estimated, reconciled statutory interest payment requirement.

Additional Features and Advantages

Other features and advantages of embodiments of the present invention include one or more of the following:

Real-Time Communication. The present invention enables users to transact Claims processing and settlement in real-time. The present invention enables networking of applications to greatly enhance the real-time communication between Providers 130 (e.g., physicians, ancillary Providers, and hospitals) and Payers 155 (e.g., insurance companies (including HMOs) and large, self-insured companies). The result is a significant reduction in the unit cost of the ever-increasing number of health care financial transactions.

Regulation Compliance. This component enables reduced risk of failure to comply with increasingly, stringent compliance, fraud, and abuse surveillance by state and federal governments. The system is set up to be secure and comply with regulatory, legislative and privacy mandates and standards. The Health Insurance Portability and Accountability Act (HIPAA), HCFA, HL7, and DHHS are regulatory, financial and data format requirements that are incorporated into the process flow and database architecture.

Scalability. The present invention is designed to grow rapidly and handle transactions from any U.S. geographic area. Furthermore, it is adaptive to how services are offered and how they are charged to end-users.

Interoperability. The present invention is not constrained by proprietary hardware or software. The underlying architecture is based on a modular, reusable design to enable plug and play capability.

Security. The present invention is secure and complies with regulatory, legislative and privacy mandates and standards.

Reliability. The present invention is capable of having 24/7/365 availability with no downtime. It is hosted, for example, in a managed hosting facility. Such a facility provides the capability for backup power, telecommunications, and site mirroring. Once a Claim is entered into the domain of the present invention by the Provider's computer, the Claims engine scrubs and processes the Claim for a diagnosis/treatment (ICD/CPT) match, up coding, unbundling, pre-certification match, coordination of benefits, Patient benefits, and so forth. The Claim arrives electronically through a secure Internet connection at the Payer's computer, is batched electronically, and then released into the Payer's computer.

Via the present invention, payment is advanced before the transaction ever goes through the Payer's computer. Payment instructions are directed through an electronic lock box residing in the domain of the present invention. These instructions are sent to the Funding Entity, Payer, and Provider's computers. Another feature to the system is the messaging and communication capabilities enabled between the Providers 130, Payers 155, Employers 170, and Funding Entities 160.

Improved ASP Practice Management System Features. The full-featured Web-based end-to-end office automation solution of an embodiment of a present invention includes eligibility, referral, compliance, cash management, prescription preparation and delivery, record dictation, EOP reconcilement, human resources, payroll management, scheduling, Claims administration and collection.

The present invention capitalizes on the failure of present day physician PMS to produce substantial savings and practice enhancement. Some of the shortcomings with today's PMS are inherent with client server applications. These include limited data storage, limited communication features and poor security. These application systems fail to deliver on their promise to be user friendly and to increase medical office efficiency and bottom line.

E-Market Exchanges. Aggregation of the Providers 130 enables enhanced procurement of products and services. One focus of this advantage is on nonmission critical products and services, such as office supplies, training, and printing. Enhancements of pre-approved credit facilities are made by employing Online Relationship Banking Integration Technology (ORBIT). The ORBIT function provides real-time interfacing with the Providers 130 and Funding Entities 160 who can customize credit products for specific offerings.

Interactive Dispute Settlement Reconcilement. The present invention can calculate, document, and reconcile the Providers/Payers unpaid Claims balance disputes. It also provides a common platform to analyze Claims balance disputes with uniform formats and data history. The present invention can also inject historical dispute settlement data and history as a factor for credit quality determination.

Statutory Interest Reconciliation and Collection. The present invention supports calculation, documentation, reconciliation, and collection of default interest associated with the Payer 155 not meeting the statutory requirements for timely payment of Claims. This greatly reduces the interest rate liability of Providers 130 providing an interest offset funding source that has historically been extremely difficult to document. The present invention also provides an incentive for Payers 155 to shorten the funding cycle by increasing the probability of incurring interest penalties.

Clearing House Processing. The present invention can aggregate the Provider EDI Claims for volume clearing house-pricing advantage. It provides a single source for Provider Claims clearing, which reduces the expense of administration by providing volume discount factors with Clearing Houses 145.

Hosting. The present invention allows a Host 180 to allow the Participants access to technology without requiring the Participants to purchase either proprietary software or computer systems.

Contact Management. The present invention includes: Email, Patient management follow-up, rescheduling of appointments for future tests, and test results follow-up.

Medical Work Management. The present invention comprises a medical work management workflow system.

Call Center. The present invention provides support and answers for office staff for questions and/or problems they may have with respect to the products and their use.

Automatic Conferencing. The present invention provides features such as automatic communications, which enable physicians to communicate and share the same medical record information captured by the system (e.g., laboratory and x-ray reports, and other ancillary testing and entered information).

Patient Support Data. The present invention provides data details for Patient compliance with respect to kept/missed appointments and timeliness.

Physician Statistical Data. The present invention enables comparison and or trending of intergroup physician productivity, physician compliance with evaluation and management guidelines, coding evaluation, and outcome analysis.

Patient Benefits Profile. The present invention assists the Providers 130 and the Patients 165 in assessing options and choices available for treatment.

Marketing. The present invention can support a variety of methods of capturing the Participants, which further enhances its value and usefulness, and which provides other advantages. These methods include: 1) Getting the Participants and/or others to endorse the present invention; 2) Presenting the products through media, trade shows and seminars; 3) Continuing Medical Education classes ported through CONCERT 120 to the Provider 130; 4) Providing office technology and needs assessment; 5) Using vendors and other channels/lists (e.g., Funding Entities 160, professionals, suppliers); 6) Using contests or promotions for office managers to create leads (a marketing database); 7) Permission e-mail marketing (buying e-mail lists); 8) Partner with existing practice management systems and medical suppliers; and 9) Produce satisfied Participants that produce potential customers.

Additional Information. The present invention can use methods of obtaining additional information, including the following: 1) Determine the formal organizational structure of the Payer organization and the relationships among the key executives; 2) Determine the informal structure and organization of the Payer 155 and how those relationships affect decision-making; 3) Determine the organization's “hot button” (which includes the organization's desire to preserve relationships with “preferred Providers”) or those key elements which most appeal to the organization and which satisfy its most currently important objectives; and 4) Obtain the cooperation of the Payers 155 to help the quality of the relationship, the ease of doing business with CONCERT 120, and the soundness of the business case.

Reduced Cost. The cost of filing, adjudication and payment of Claims is borne by each component of the healthcare system. By providing secure, real-time, adjudication and payment of Claims, physicians, other Providers 130 (e.g., hospitals), Payers 155 and, ultimately, the taxpayer, save money.

Data Collection. CONCERT 120 captures significant healthcare data related to trends, Patient history, utilization, payments, etc., which are extremely valuable to many health care organizations. The collection, organization, and accessibility of this data created by CONCERT 120 enables Participants in the health care system to better optimize both the financial and medical outcomes.

Reduce Fraud and Abuse. The invention enables reduced risk of failure to comply with increasingly stringent compliance, fraud and abuse surveillance by state and federal governments. The federal government is clearly increasing its efforts to detect and punish Medicare and Medicaid fraud and abuse. Through the Office of the Inspector General, increased resources have been allocated and tougher penalties instituted for successful prosecution of cases of fraud and abuse. The Department of Health and Human Services, the Justice Department and the FBI reportedly have allocated over $1 billion in funding for these investigations. It is estimated that 75% of all hospitals are investigated. The federal government has already reportedly recovered over $1.8 billion from successful prosecution of whistle-blower lawsuits. Almost every component of service delivery and billing is vulnerable. It is irrelevant if the acts are intentional or unintentional; penalties are possible in both. The Civil False Claims Act has raised concerns in the health care industry due to its imposition of heavy penalties between $5,000 to $10,000 per Claim plus treble damages. Serious penalties may also be imposed under Medicare and Medicaid anti-fraud and abuse laws including exclusion from participation in the Medicare and Medicaid programs.

Health care Providers 130 have attempted to develop corporate compliance programs that might be effective in reducing the risk of errors or wrongdoing, which in turn could lead to protracted investigations and criminal and civil charges. By voluntarily developing such programs and implementing control mechanisms that support such programs, health care Providers 130 can reduce potential investigations, fines and their overall exposure.

Increased Compliance. The present invention supports physician compliance efforts by establishing and implementing rules, preventing or correcting billing and coding errors and reporting inconsistencies with predetermined sets of guidelines. These Rulesets, which are complex and continuously change, are created in concert with Payers 155 and are used to evaluate Claims and Claims history for compliance automatically. Since Medicare is thought to have lost in excess of $13.5 Billion due to fraud in 1999, every medical Provider 130 is under increased scrutiny from several government agencies. Healthcare institutions and Providers 130 have already invested in internal monitoring and computer systems to oversee billing and Claims activities. However, The American Hospital Association states that this may not be enough and that traditional management control mechanisms are already outdated and under-equipped to handle today's accelerated pace of change. The present invention offers an additional level of audit and control.

Attraction of Additional Providers. With a critical mass of Payers 155 and Providers 130, attracting other ancillary Providers 130 for Claims processing is achieved with little incremental cost and great economic benefits to service providers for the present invention.

Can Include Other Applications. Other applications are able to be ported into the system for Providers 130, such as financial reporting packages, wealth management, procurement of supplies, and others.

Service Provider Opportunities. Service providers for the present invention can become application service providers for Payers 155 and Funding Entities 160. With the system capability, additional revenues can be generated, for example, through Payer 155 outsourcing of Claims processing and bank outsourcing of asset based lending, asset securitization funding and management.

Data Mining. Data mining opportunities include storing and leveraging the medical data collected. Analysis of future trends is made possible, including reporting on when a physician is over or underutilized. The creation of proactive actions is made possible, such as by providing the capability to include a “tickler file” to remind a physician to schedule another appointment for a Patient 165, or monitoring the entire “supply chain” Patient 165, Provider 130, Payer 155 and Funding Entity 160 for further efficiencies.

Strategic Alliances. Further advantages of the present invention are capable of being achieved through use of the invention in conjunction with strategic alignments with several Funding Entities 160 with strong private banking practices. It is not necessary to be aligned with an individual Provider's bank; however, it is essential to bring a good line of credit vendor/proposal for the Provider 130.

Reduced Workload. The present invention reduces the time and amount of work required to handle the entire Claims process. Among other reasons, this reduced workload is accomplished by providing a hosted practice management system.

Reduced Training. The present invention minimizes the training required. This is accomplished through an effective and easy user interface.

Increased Claim Share. In the event an interface cannot be made with all Payers 155, provisions are included to integrate Claims Clearing Houses 145 into the system to ensure the Provider 130 can process the majority of their Claims.

Comprehensive Provider-to-Provider Referral Network. The communication network with Providers 130 and Payers 155 built via use of the present invention facilitates referrals.

Supported Payer Rules of Engagement. The present invention enables business to be conducted with the Payer 155 in any manner they select. It is preferred to have as much data as possible within the processing environment of the present invention. However, a variety of scenarios can be supported, ranging from clients having all data to virtually none of their data being included in the CONCERT 120 processing environment.

APIs. The present invention writes and owns APIs for all systems with which it interacts, especially with Payer systems. In one embodiment, if the Payer 155 writes the API, the Payer 155 has the right to give it away to the next competitor. If the API is written by the Provider 130, in an embodiment of the present invention, the work needs to be replicated by a competitor of the Provider 130. This work raises the time and money hurdle for a competitor.

Virtual Workspace. The present invention provides web access and virtual workspace for system Participants to view reports, information, and data on a realtime basis. This makes it easy to do business via the method and system of the present invention, and thus potentially to improve internal processes of users.

Shortened Sales Cycle. Once even one or two Payers 155 are up and running, the sales cycle is shortened in the market.

Specific Provider Benefits. Benefits to Providers 130 include the following: 1) Advanced deposit of funds for Claims submitted; 2) Providers 130 are left free to focus on core competencies of delivering Patient care; 3) Reconciliation of EOPs occurs in real-time; 4) Reduction occurs in office operating costs; 5) Real-time pre-adjudication and payment of Claims are made; 6) Real-time eligibility and pre-certification occur; 7) Reduced rejection rate of Claims is obtained; 8) Reduced risk of non-compliance, fraud and abuse results; 9) Historical Claims data is collected to furnish analysis of Patient history; 10) Low (or no) implementation cost results; 11) Reduced accounts receivables is obtained; and 12) Judgment-proof receivables are created.

Specific Payer Benefits. The present invention provides the following benefits to Payers 155: 1) Significant operating cost reduction, including reduction in Call Center 140 costs and automation of manual processes; 2) Increased Provider 130 satisfaction (A primary area is incorporation of formularies into the script writing procedure. By automatically scrubbing the script against Payer formulary, the Patient 165 obtains an approved prescription, and the physician avoids an angry Patient 165 who cannot fill their script.); 3) Assistance in bringing Providers 130 into government compliance and reducing the risk of fraud and abuse in real-time; 4) Providing a web enrollment module to facilitate administration of benefit plans for Employers 170; 5) Providing HEDIS reports to help get and maintain National Comrnmittee on Quality Assurance (NCQA) accreditation; 6) Help with Blue Cross/Blue Shield organizations with their NMIS reports, which are used to evaluate their effectiveness; 7) Reduction in their IBNR. (For example, Payers 155 are being required by legislative action to pay clean Claims within a 30 day time period. The benefit of “reimbursement float” has been legislated away.); and 8) Reduction in the overall cost of health care.

Specific Funding Entity Benefits. Benefits to Funding Entities 160 include the following: 1) Expanded market opportunity to include an increase in core deposits relationships; 2) Improvement in Risk Assessment Return on Capital (RAROC); 3) Reduction in Allocation for Reserve for Loan Losses; 4) Increase in yield on portfolio by maximizing risk based capital allocation; 5) Time to market advantage by outsourcing to ASP; 6) Material transaction cost reduction within the ASP model; 7) Incremental administration and audit cost; 8) Significant Credit Risk reduction-real-time compliance, auditing and data management within a secured STP system. 9) Retention and expansion of Preferred Customer Profile Accounts-Physicians Increase in Fee Income by leveraging investment and annuity products; and 10) Enhanced security and privacy capabilities.

Example embodiments of the present invention have now been described in accordance with the above advantages. It will be appreciated that these examples are merely illustrative of the invention. Many variations and modifications will be apparent to those skilled in the art.

What is claimed is:

1. A method for pre-adjudication, funding, and payment of medical expenses to a Provider for a medical expenses claim, the claim having an associated amount, wherein a line of credit is established, the method comprising:
receiving the claim from the Provider;
prior to adjudication of the claim, funding a portion of the claim to the Provider from the line of credit; and
collecting the amount of the claim from a Payer.

2. The method of claim 1, further comprising:
repaying the line of credit from the collected amount.

3. The method of claim 1, wherein the Provider is selected from a group consisting of a physician or a hospital.

4. The method of claim 1, wherein the Payer is an insurance company.

5. The method of claim 1, wherein the line of credit is established by a financial institution.

6. The method of claim 1, further comprising:
receiving a claim from the Provider; and
scrubbing the claim.

7. The method of claim 6, wherein scrubbing the claim comprises:
validating data for the claim.

8. The method of claim 6, wherein scrubbing the claim further comprises:
comparing the data to Rulesets.

9. The method of claim 6, wherein checking the claim comprises:
passing the claim payment request through a Verified Enhanced Term Sheet (VETS);
comparing data for the claim to Rulesets; and
submitting a claim payment request to a Financial Institution for approval.

10. The method of claim 9, wherein the VETS comprises a criteria and funding management process.

11. The method of claim 1, further comprising:
taking a secured interest in the claim.

12. The method of claim 1, further comprising:
completing a risk analysis of the claim.

13. A system for pre-adjudication and payment of medical expenses to a Provider for a medical expenses claim, wherein a line of credit is established, the system comprising:
terminals coupled to a network for receiving and transmitting claim information for the Provider, a Payer, and a Financial Institution; and
a server coupled to the network for receiving and transmitting claim information;
wherein a claim is received from the Provider;
wherein, prior to adjudication of the claim, claim payment is provided to the Provider from the line of credit; and
wherein the amount of the claim payment is collected from a Payer.

14. The system of claim 13, wherein the line of credit is repaid from the collected Payer payment.

15. The system of claim 13, wherein the Provider is selected from a group consisting of a physician or a hospital.

16. The system of claim 13, wherein the Payer is an insurance company.

17. The system of claim 13, wherein the line of credit is established, used to pay the Provider, and repaid by a Financial Institution.

18. The system of claim 13, wherein:
a claim request is received from the Provider;
the claim request is scrubbed; and
approval or denial is sent to the Provider.

19. The system of claim 18, wherein the claim request is scrubbed by:
validating the data for the claim.

20. The system of claim 18, wherein scrubbing the claim further comprises:
comparing the data to Rulesets.

21. The method of claim 1, wherein:
a claim is received from the Provider;
the claim is checked; and
if the claim is approved, the Provider is paid with the line of credit;
if the claim is denied, the Provider is sent a notice of denial.

22. The method of claim 21, wherein checking the claim further comprises:
passing the claim payment request through a VETS Financial Institution choice;
approving Rulesets; and
submitting the claim to the Financial Institution for approval.

23. The system of claim 13, wherein the network is a Virtual Private Network.

24. The system of claim 13, wherein the network is an Internet.

25. The system of claim 13, further comprising a proxy server to manage traffic on the network.

26. The system of claim 13, further comprising a browser to allow users to view documents and access files and software.

27. The System of claim 13, further comprising interfaces to allow users to view documents and access files and software.

28. The System of claim 13, further comprising a call center coupled to the network to provide users support and answers for questions and problems the users have with the system.

29. The system of claim 13, further providing a clearing house coupled to the network.

30. The system of claim 13, further comprising a firewall coupled to the network to protect the network against external threats.

31. The system of claim 13, further comprising coupling to couple various components to the network.

32. The system of claim 13, comprising terminals coupled to the network.

33. The system of claim 13, comprising servers coupled to the network.
